(19) United States
(12) Patent Application Publication
(10) Pub. No.: US 2025/0240862 A1
(43) Pub. Date: Jul. 24, 2025

(54) SYSTEMS AND METHODS FOR SMART LIGHTING SYSTEM

(71) Applicant: Smart Escape LLC, Mendon, MA (US)

(72) Inventors: Kevin P. Healy, Mendon, MA (US); Noah B. Boudreau, Douglas, MA (US); Benjamin M. Watson, Mendon, MA (US); Zachary A. Rivernider, Mendon, MA (US)

(73) Assignee: Smart Escape LLC, Mendon, MA (US)

(21) Appl. No.: 19/033,282

(22) Filed: Jan. 21, 2025

Related U.S. Application Data
(60) Provisional application No. 63/623,421, filed on Jan. 22, 2024.

(51) Int. Cl. H05B 47/17; G08B 5/38; G08B 21/02; H05B 47/105; H05B 47/155; H05B 47/16

(52) U.S. Cl. CPC H05B 47/172; G08B 5/38; G08B 21/02; H05B 47/105; H05B 47/155; H05B 47/16

(57) ABSTRACT

A method executable by a computing system using a lighting system to navigate a building space, the method may include receiving a notice of an event. The method may include determining a location of the event and a type for the event and determining one or more navigation paths along the plurality of pathways within the building space for which one or more persons are to navigate to an egress of the building, based on the location and type of the event. The method may include causing one or more hubs of a plurality of hubs corresponding to the one or more navigating paths to provide the one or more visual indicators.

### CROSS REFERENCE TO RELATED PATENT APPLICATIONS

The present application claims the benefit of and priority to U.S. Provisional Patent Application No. 63/623,421 filed on Jan. 22, 2024, the disclosure of which is incorporated herein by reference in its entirety.

### TECHNICAL FIELD

The present disclosure relates generally to using systems and methods to safely help occupants of a space to escape the space.

### BACKGROUND

The growth of computing systems have allowed for increased performance, enhanced capabilities, and increased energy efficiency. Many systems within a building space utilize processors including emergency alert systems, building automation systems, communication systems, and surveillance. For example, a school building may use a fire alarm to alert the occupants of the school building of potential danger. Conventional computer-implemented methods can alert occupants of events which may be deemed as dangerous or necessary to react to.

Conventional software solutions and computer-implemented methods suffer from a technical shortcoming. For instance, using state of the art alert systems does not provide occupants with a most accurate navigation path to escape the building space because conventional solutions typically communicate via sounds and signs to indicate where an exit is located. Furthermore, conventional software solutions cannot generate nor adjust the navigation paths depending upon real time updates of the events. In order to combat the above-described technical shortcoming, organizations are forced to rely on fire alarms and exit signs which may not guarantee safety.

### SUMMARY

Aspects of the technical solutions described herein relates to a method executable by a computing system using a lighting system to navigate a building space, the method may include receiving a notice of an event. The computing system may be in communication with a lighting system. The lighting system may include a plurality of hubs arranged along a plurality of pathways within a space of the building to one or more egresses of a building. Each of the plurality of hubs may include one or more visual indicators to indicate a direction towards an egress along one or more of the plurality of pathways and to indicate a direction to avoid based on the event. The method may include determining a location of the event and a type for the event and determining one or more navigation paths along the plurality of pathways within the building space for which one or more persons are to navigate to an egress of the building, based on the location and type of the event. The method may include causing one or more hubs of the plurality of nodes corresponding to the one or more navigating paths to provide the one or more visual indicators.

Aspects of the technical solution described herein related to a computing system. The computing system can include one or more visual indicators, a plurality of hubs, a lighting system, a fire alarm control unit, and a main hub that includes one or more processors coupled with memory. The one or more processors can receive, a notice of an event. The main hub can be in communication with the lighting system. The lighting system can include plurality of hubs arranged along a plurality of pathways within a space of the building to one or more egresses or one or more locations of a building. Each of the plurality of hubs can include one or more visual indicators to indicate a direction towards an egress or a location along one or more of the plurality of pathways and to indicate a direction to avoid based on the event. The one or more processors can determine, responsive to the notice, a location of the event and a type for the event. The one or more processors can determine one or more navigation paths along the plurality of pathways within the building space for which one or more persons are to navigate to the egress or location of the building, based on the location and type for the event. The one or more processors can cause one or more hubs of the plurality of hubs corresponding to the one or more navigating paths to provide the one or more visual indicators in accordance with the location and type for the event.

### BRIEF DESCRIPTION OF THE DRAWINGS

FIG. 1 illustrates components of a smart lighting system, according to an embodiment.

FIG. 2A-2P illustrates a flow diagram of a method executed in the smart lighting system, according to an embodiment.

FIG. 3A-3S illustrates another flow diagram of a method executed in the smart lighting system, according to an embodiment.

FIG. 4A-4F illustrates another flow diagram of a method executed in the smart lighting system, according to an embodiment.

FIG. 5 illustrates another flow diagram of a method executed in the smart lighting system, according to an embodiment.

FIG. 6 illustrates another flow diagram of a method executed in the smart lighting system, according to an embodiment.

FIG. 7 illustrates an example schematic of the smart lighting system, according to an embodiment.

FIG. 8A illustrates a top-side view of indicators of the smart lighting system with cables attached, according to an embodiment.

FIG. 8B illustrates a bottom-side view of the indicators with cables attached of the smart lighting system, according to an embodiment.

FIG. 9A illustrates a top-side view of the indicators of the smart lighting system, according to an embodiment.

FIG. 9B illustrates a bottom-side view of the indicators of the smart lighting system, according to an embodiment.

FIG. 10A illustrates a top-side view of the indicator of the smart lighting system, according to an embodiment.

FIG. 10B illustrates a bottom-side view of the indicator of the smart lighting system, according to an embodiment.

FIG. 11 illustrates an example light system of the smart lighting system, according to an embodiment.

FIG. 12 illustrates an example main hub of the smart lighting system, according to an embodiment.

FIG. 13 illustrates indicators of the smart lighting system within a pathway, according to an embodiment.

FIG. 14 illustrates an example of a green light of the indicator in the smart lighting system, according to an embodiment.

FIG. 15 illustrates an example of a red light of the indicator in the smart lighting system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

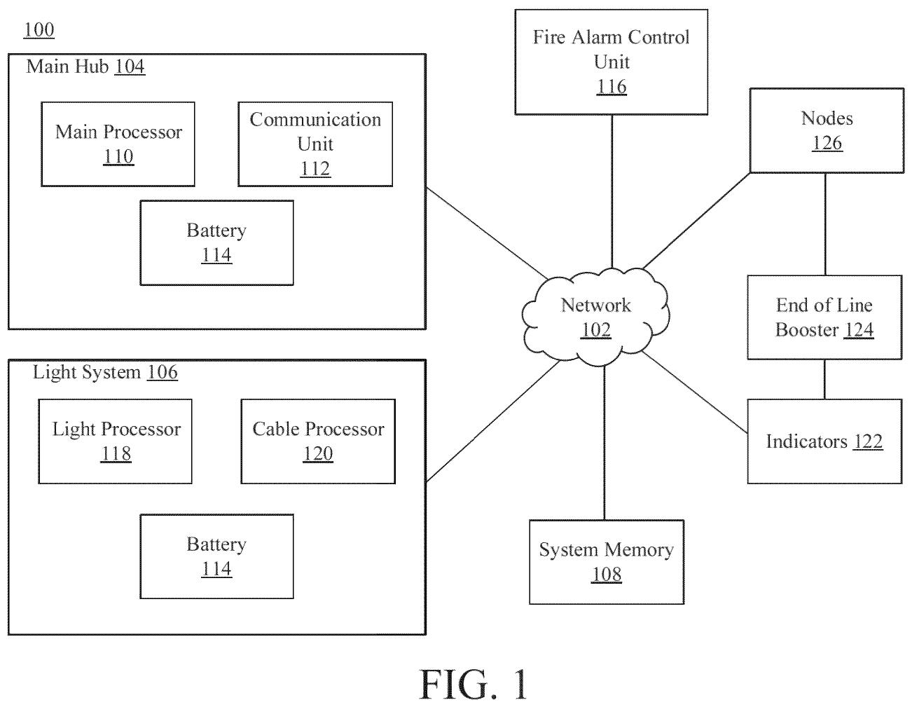

FIG. 1 illustrates components of a smart lighting (SL) system 100 of a building space. The building space may include a plurality of rooms and a plurality of pathways. The system 100 may include a network 102, a main hub 104, a light system 106, system memory 108, a Fire Alarm Control Unit 116 (FACU), indicators 122, an End of Line Booster 124 (ELB), and nodes 126. The above-mentioned components may be connected to each other through a network 102. The examples of the network 102 may include, but are not limited to, private or public LAN, WLAN, MAN, WAN, and the Internet. The network 102 may include both wired and wireless communications according to one or more standards and/or via one or more transport mediums.

The communication over the network 102 may be performed in accordance with various communication protocols such as Transmission Control Protocol and Internet Protocol (TCP/IP), User Datagram Protocol (UDP), Long Range Wide Area Network (LoRaWAN), and IEEE communication protocols. In one example, the network 102 may include wireless communications according to Bluetooth specification sets, or another standard or proprietary wireless communication protocol. In another example, the network 102 may also include communications over a cellular network, including, e.g., a GSM (Global System for Mobile Communications), CDMA (Code Division Multiple Access), EDGE (Enhanced Data for Global Evolution) network.

The system 100 is not confined to the components described herein and may include additional or alternate components, not shown for brevity, which are to be considered within the scope of the embodiments described herein.

The main hub 104 can include a physical computer system operatively coupled or that can be coupled with one or more components of the system 100, either directly or through an intermediate computing device or system. The main hub 104 can be in communication with or operatively couple with a plurality of sensors through a building, such as smoke detectors, heat sensors, gunshot detectors, pressure sensors, light sensors, air quality sensors, motion sensors, carbon monoxide detectors, among other sensors/detectors. The main hub 104 can include a virtual computing system, an operating system, and a communication bus to effect communication and processing. The main hub 104 may include a main processor 110, a communication unit 112, and a battery 114.

The main processor 110 can execute one or more instructions associated with the system 100. The main processor 110 can include an electronic processor, an integrated circuit, or the like including one or more of digital logic, analog logic, digital sensors, analog sensors, communication buses, volatile memory, nonvolatile memory, and the like. The main processor 110 can include, but is not limited to, at least one microcontroller unit (MCU), microprocessor unit (MPU), central processing unit (CPU), graphics processing unit (GPU), physics processing unit (PPU), embedded controller (EC), or the like. The main processor 110 can include a memory operable to store or storing one or more instructions for operating components of the main processor 110 and operating components operably coupled to the main processor 110. For example, the one or more instructions can include one or more of firmware, software, hardware, operating systems, embedded operating systems. The main processor 110 or the system 100 generally can include one or more communication bus controllers to effect communication between the main processor 110 and the other elements of the system 100.

The system memory 108 can store data associated with the system 100. The memory 108 may include one or more hardware memory devices to store binary data, digital data, or the like. The system memory 108 can include one or more electrical components, electronic components, programmable electronic components, reprogrammable electronic components, integrated circuits, semiconductor devices, flip flops, arithmetic units, or the like. The memory 108 may include at least one of a non-volatile memory device, a solid-state memory device, a flash memory device, and a NAND memory device. The memory 108 may include one or more addressable memory regions disposed on one or more physical memory arrays. A physical memory array can include a NAND gate array disposed on, for example, at least one of a particular semiconductor device, integrated circuit device, or printed circuit board device.

The communication unit 112 can link the main hub 104 with one or more of the network 102 the light system 106, the FACU 116, and the indicators 122, by one or more communication interfaces. A communication interface can include, for example, an application programming interface (“API”) compatible with a particular component of the main hub 104, the light system 106, the FACU 116, and the indicators 122. The communication interface can provide a particular communication protocol compatible with a particular component of the main hub 104 and a particular component of the light system 106, the FACU 116, or the indicators 122.

The battery 114 may include a cathode, an anode, and an electrolyte solution in between the anode and the cathode. The battery 114 may include a material disposed inside battery 114 depending upon the type of battery 114. The type of the battery 114 can be Lithium-Ion, Lead-Acid, Nickel-Cadmium, Alkaline, or Solid State, among others. For example, the battery 114 may be a Lithium-Ion battery. In another example, the battery 114 may be a Lead-Acid battery. The battery 114 may output a voltage to supply current to the main hub 104. For example, the main hub 104 may require 120 Volts (V) to effectively communicate with the light system 106, the FACU 116, and the indicators 122. In some arrangements, the battery 114 may be rechargeable or non-rechargeable.

The FACU 116 may be a central control hub for a fire alarm system of a building space. The FACU 116 may control and monitor a plurality of devices throughout the building space. The plurality of devices may include at least one of a smoke detector, a heat detector, a flame detector, and a pull station, among others. The plurality of devices may be configured to detect and respond to the presence of smoke, fire, high levels of carbon monoxide, sharp temperature changes, or water pressure changes, among others. For example, the FACU 116 may receive an indication from a smoke detector where the indication includes a signal acknowledging the presence of smoke. In another example, the FACU 116 may turn off a fire alarm when the fire has been extinguished.

The FACU 116 may initiate responses based upon the plurality of devices. For example, one node 126 in the plurality of devices may detect a fire and send a signal to the FACU 116. The FACU 116 may activate the fire alarm system and alert emergency responders. The FACU 116 can include a fire alarm control panel that receives one or more signals from initiating devices to activate the fire alarm system. The initiating devices can be any device that triggers the activation of the fire alarm of the FACU 116. The fire alarm control panel can signify a supervisory condition to identify an issue with the system 100 or a connected system. The supervisory condition can call a central station so a user can be notified of the problem.

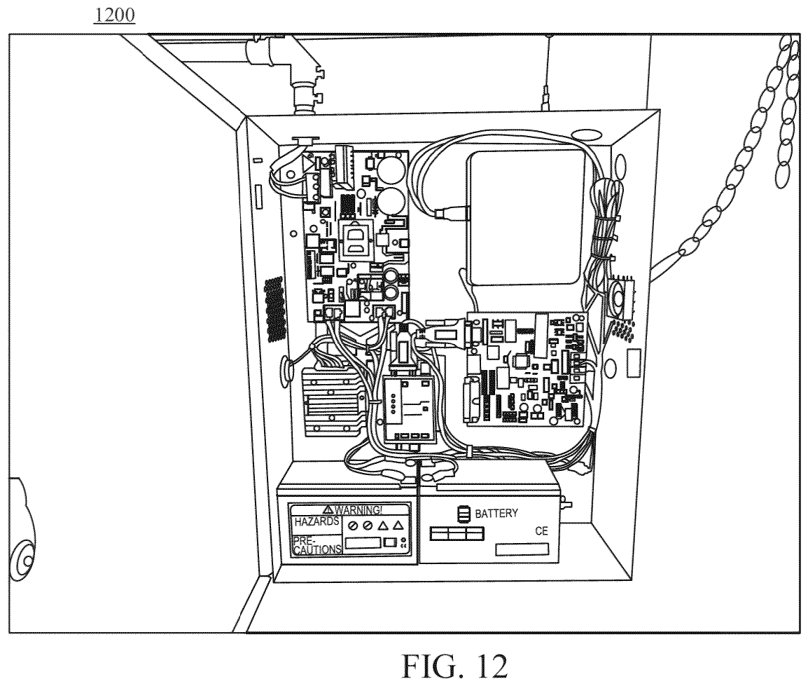

The main hub 104 may be a central control panel for the smart lighting system, located next to the FACU 116 and connected directly to the FACU 116. Thus, the main hub 104 may allow for monitoring of the processes within the system 100. For example, the main hub 104 may monitor the nodes 126 in response to an event. The event may include at least one of a medical emergency, fire emergency, evacuation, earthquake, active shooter, or chemical emergencies, among others. The main hub 104 may communicate with the FACU 116 through a wired connection, via the communications unit 112, or over the network 102. In some arrangements, the main hub 104 may be located directly next to the FACU 116. For example, the FACU 116 may receive a signal from one or more devices in the plurality of devices. The FACU 116 may transmit the signal via a serial or parallel bus to the main hub 104. In another example, the FACU 116 may receive a signal from one or more devices in the plurality of devices and may transmit the signal via the network 102 to the main hub 104. The main hub 104 may identify the type of event that has occurred. For example, an occupant of the building space may interact with the pull station in the plurality of devices. The main hub 104 may first communicate with the FACU 116 to determine whether the pull station was in response to a fire or a presence of smoke. If the determination is not made, the main hub 104 may access a plurality of cameras to identify the type of event. FIG. 12 illustrates an example main hub 1200 of the smart lighting system 100.

The main hub 104 may coordinate the components of system 100 to ensure each component is triggering synchronously with each component. For example, the main hub 104 may restrict the function of the light system 106 until an event was detected by the FACU 116 or by the nodes 126. In another example, the main hub 104 may allow for the use of the light system 106, without an event occurring within the FACU 116. In some arrangements, the main hub 104 may control each of the components of system 100. Controlling the components may include absolute control of partial control. For example, the main hub 104 may control the indicators 122 during an event and prevent the light system 106 from interacting with the indicators 122. This instance allows the main hub 104 to have absolute control. In another example, the main hub 104 may control the light system 106 while no events have been triggered, but the FACU 116 may take control of the light system 106 when an event occurs. This instance allows the main hub 104 to have partial control.

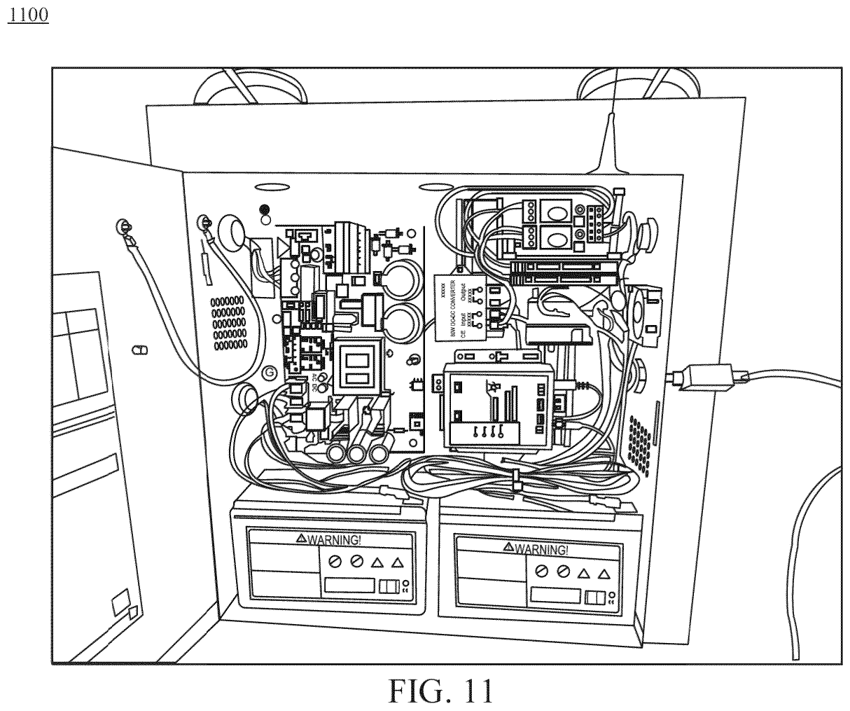

The light system 106 can include a physical computer system operatively coupled or that can be coupled with one or more components of the system 100, either directly or through an intermediate computing device or system. The light system 106 can include a virtual computing system, an operating system, and a communication bus to effect communication and processing. The light system 106 may include a light processor 118, a cable processor 120, and a battery 114. FIG. 11 illustrates an example lighting system 1100 of the smart lighting system 100.

The light processor 118 can execute one or more instructions associated with the system 100. The light processor 118 can include an electronic processor, an integrated circuit, or the like including one or more of digital logic, analog logic, digital sensors, analog sensors, communication buses, volatile memory, nonvolatile memory, and the like. The light processor 118 can include, but is not limited to, at least one microcontroller unit (MCU), microprocessor unit (MPU), central processing unit (CPU), graphics processing unit (GPU), physics processing unit (PPU), embedded controller (EC), or the like. The light processor 118 can include a memory operable to store one or more instructions for operating components of the light processor 118 and operating components operably coupled to the light processor 118. For example, the one or more instructions can include one or more of firmware, software, hardware, operating systems, embedded operating systems. The light processor 118 or the system 100 generally can include one or more communication bus controller to effect communication between the light processor 118 and the other elements of the system 100.

The light system 106 may include a hard-wired connection to a plurality of light systems 106 within the building space. The light systems 106 may be placed in the building space relative to the location of the indicators 122. In some arrangements, each of the plurality of light systems 106 may communicate with the main hub 104 via the network 102. In some arrangements, each of the plurality of light systems 106 may communicate with each of the plurality of light systems 106 in system 100. The light processor 118 may control and identify any signals and indications from the indicators 122. The light processor 118 may determine a plurality of colors for the indicators 122. For example, the main hub 104 may determine that an event is a rescue event and send the event to the light system 106. In response to the determined event, the light processor 118 may send a signal to the indicators 122 to change the colors to blue. The light system 106 may use LoRaWAN communication protocol to receive one or more signals from the main hub 104.

The cable processor 120 may continuously monitor the integrity of each cable in a plurality of cables within the building space. In some arrangements, the cable processor 120 is hardwired to the plurality of cables. For example, the cable processor 120 may receive an indication when a cable is no longer responsive. The cable processor 120 may transmit the indication to the main hub 104. In response to the indication, the main hub 104 may request a technician to repair the faulty wire. The cable processor 120 may send suggestions and recommendations to the main hub 104 for each cable. For example, the cable processor 120 may send a message to the main hub 104. The message may include a list of each cable in the plurality of cables. The list can include the location of each cable and an integrity percentage of the cable.

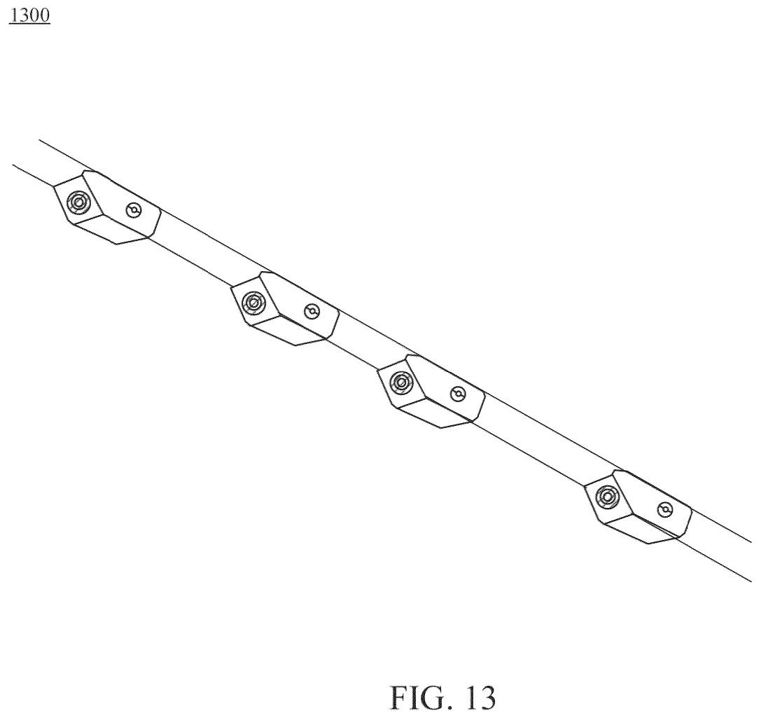

The message may further include a suggestion for one or more cables to be checked by a technician. Each pathway in the plurality of pathways may include a plurality of indicators 122 as shown in FIG. 13. FIG. 13 illustrates the plurality of indicators 122 of the smart lighting system within the pathway. The plurality of indicators 122 can form a channel. The channel can be a chain of indicators that originates from the light system 106. A segment can be a small section of the channel. There may be a plurality of segments of the channel and the plurality of segments can include every indicator 122 located between the one or more nodes 126. In some arrangements, each segment in the plurality of segments have an established length and correspond to specific physical locations within the building space.

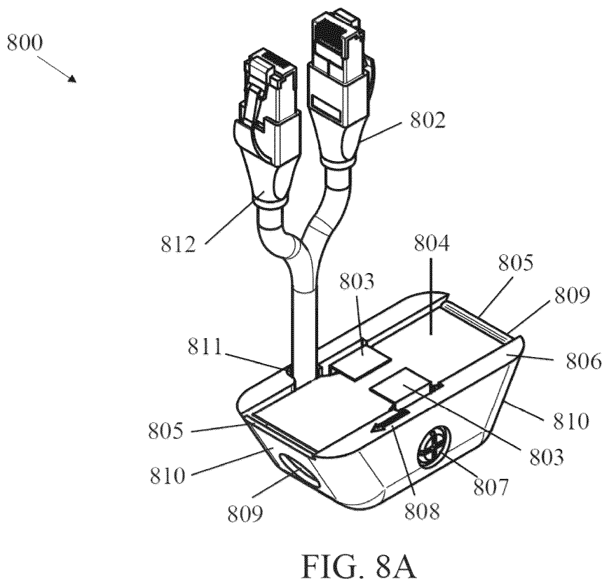

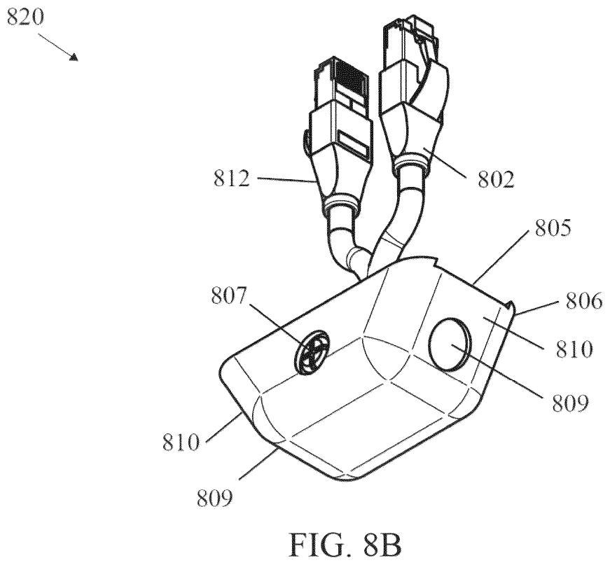

Referring now to FIGS. 8A-8B illustrates a top-side view and a bottom side view of an indicator 122 of the smart lighting system. The indicator 122 may include an input cable 802. The input cable 802 may be made from CAT6 cabling. The cable is used to transmit data signals to illuminate LEDs 902 and to transmit power to the indicator. A CAT6 coupler may be used in conjunction with the input cable to extend the cable to the next indicator.

The indicator housing 806 can be coupled to a stainless steel clip 803 (referred to as “clip” herein). The clip 803 has a ninety degree bend and a circular hole in its lower half. The clip has a sharp edge to secure it to the top of the support beam (and underneath the ceiling tile) and to prevent lateral movement. The binding screw 807 is inserted through the clip 803 hole in order to secure it to the indicator 122.

The indicator 122 can include a cardstock backing 804 that covers internal indicator 122 wires in order to prevent the drop ceiling tile support beams from coming into direct contact with internal indicator wires. The cardstock backing 804 is used as a location to mark indicator serial number and date of manufacture. The indicator 122 can include a small depression 805 that forms a channel the width of a drop ceiling tile support beam and allows the indicator to fit flush to the ceiling. The indicator 122 can include an indicator housing 806. The indicator housing 806 can be made entirely from plastic and holds all internal indicator components. The indicator 122 can include a binding post and screw 807 that secure the clips 803.

The indicator can include an arrow 808 to indicate the direction of the indicator 122. The arrow 808 is used during installation and ensures that all indicators 122 in a chain are installed facing the same direction to prevent LED 902 asynchronization. A transparent plastic insert can be placed in front of the hole (referred to as “hole 1003” herein) to protect the internal indicator's LEDs 902. The indicator 122 can include an angled wall 810 that allows the internal indicator LED 902 to be viewed from afar but not from up close. This prevents simultaneous viewing of both indicator LEDs 902 from directly below the indicator. The indicator 122 can include an indented wall 811 to allow CAT6 cabling 802 and 812 to wire around the ceiling grid track and the ceiling tile. The indent matches the size of the CAT6 cabling and holds it in place. The indicator can include an output cable. The output cable 812 may be made from CAT6 cabling. The output cable 812 is used to transmit data signals to illuminate LEDs 902 and to transmit power to the indicator 122. A CAT6 coupler may be used in conjunction with the output cable 812 to extend the cable to the next indicator 122.

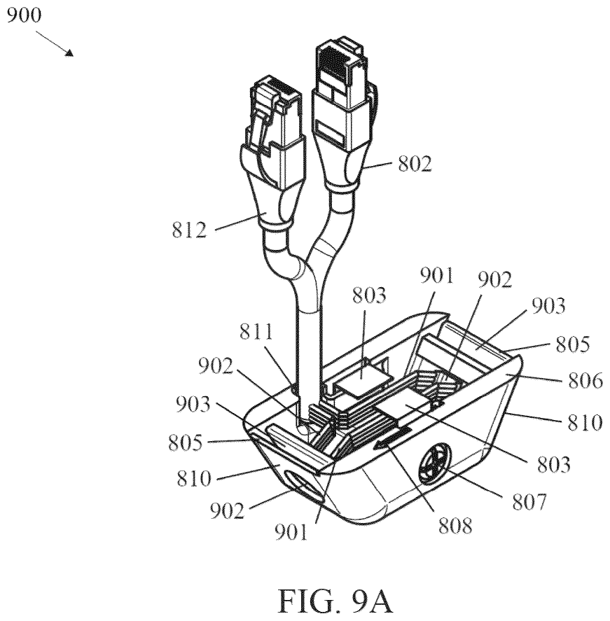

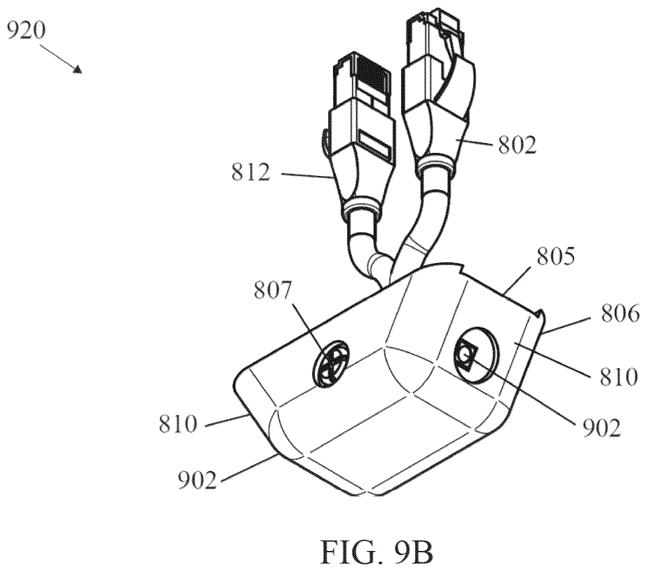

FIG. 9A-9B illustrates the top-side view and the bottom side view of an indicator 122 of the smart lighting system 100. The indicator 122 can include an internal 24 gauge wiring 901 for the LEDs 902 connected to the CAT6 cabling 802 and 812. The indicators can include internal indicator LEDs 902. The LEDs 902 are able to light up the colors: red, green, and blue in any combination of power allowing for any color to be displayed. The directional lensing is used to create peak brightness that is orthogonal from the base of the LED 902. The LEDs 902 may be connected internally to the CAT6 cabling 802 and 812 with 24 gauge wires 901. LEDs 902 placed in holes 1003 to ensure correct alignment with the other components of indicator 122. The indicator 122 can include a slot 903 for a transparent plastic insert 809 to be installed.

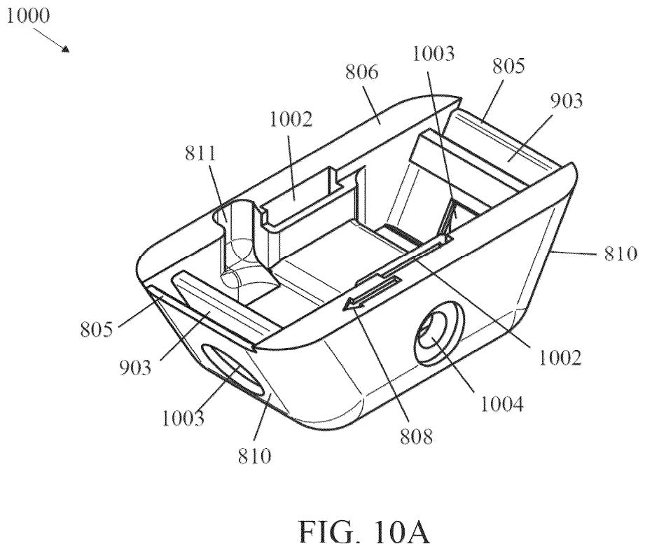

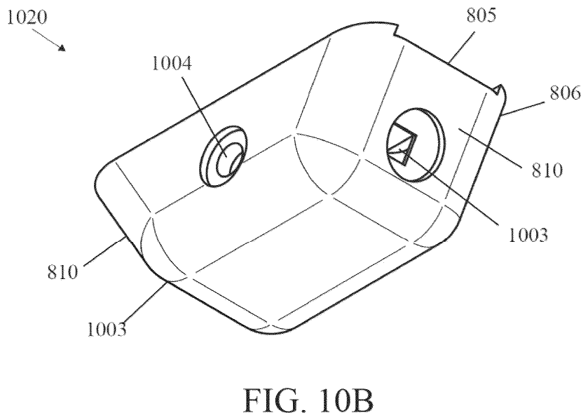

FIG. 10A-10B illustrates the top-side view and the bottom side view of an indicator 122 of the smart lighting system 100. The indicators can include a slot 1002 for the clips 803, a hole 1003 to align the internal indicator LEDs, a hole 1004 for the binding screw to insert into.

The indicators 122 may include bidirectional LED lighting. The bidirectional LED lighting may change to a plurality of colors. Each color of the plurality of colors may associate with a message to transmit to one or more occupants observing the plurality of colors of the indicators 122. For case of description, the plurality of colors may include red, yellow, green, or blue among others. For example, one indicator 122 may have a green color. The message associated with the green color may tell occupants to proceed in the direction of the green color. In another example, one indicator 122 may have a red color. The message associated with the red color may tell occupants to avoid the direction of the red color. In yet another example, one indicator 122 may have a blue color. The message associated with the blue color may tell a medical professional to proceed in the direction of the blue color.

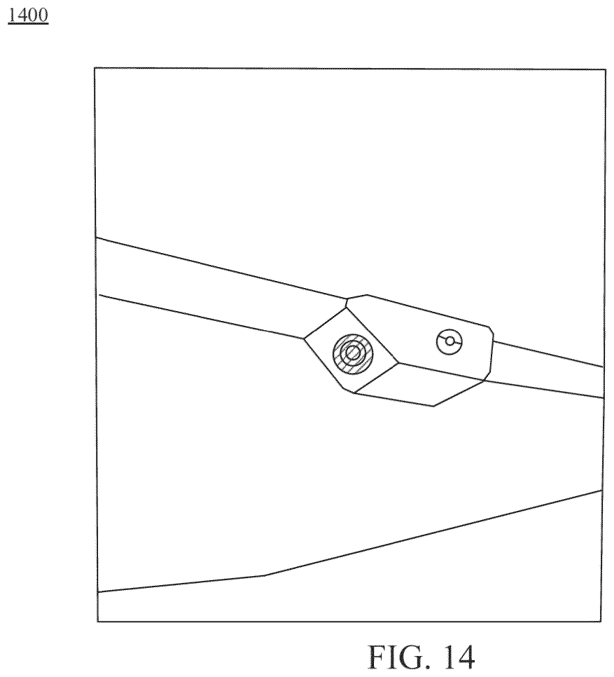

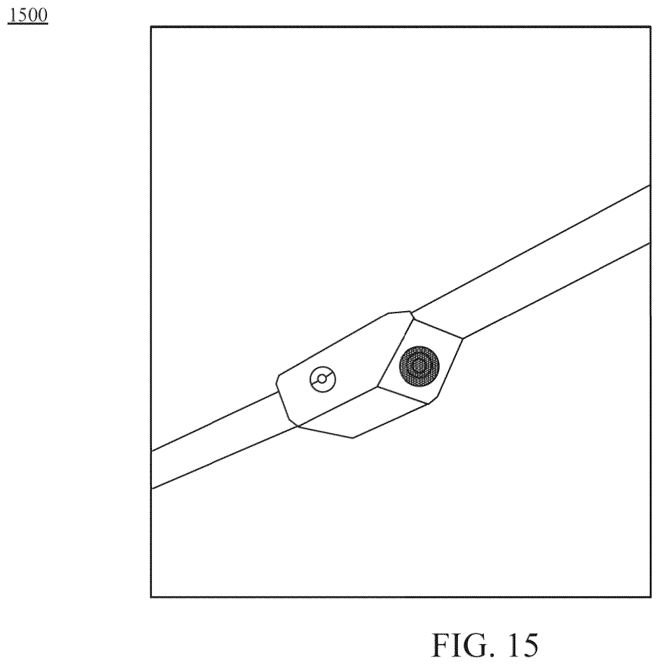

In some arrangements, both directions of the Bidirectional LED lighting may be controlled individually by the light system 106 or the light processor 118. FIG. 14 and FIG. 15 illustrates a bottom-side view of the indicators 122 of the smart lighting system 100. For example, the light processor 118 may control an indicator 122 by sending a signal to change the left light of the indicator 122 to red and the right light of the indicator 122 to green. Using two colors in the one indicator 122 may provide a visual indication to the occupants. The visual indication may give direction to the occupants. In some arrangements, one or more indicators 122 may illuminate the same color pattern in a pathway. For example, a pathway can have ten indicators 122 mounted on the roof. The light hub 106 may transmit a signal to each of the ten indicators 122 to have the left light illuminate green and the right light illuminate red. The ten indicators 122 may form a light pattern to establish a navigation path for the building space. In some arrangements, each indicator 122 of the indicators 122 may be controlled independently. For example, one indicator 122 may have a green color for the right light and a yellow color for left light. A second indicator 122 may have a yellow color for both the right and left light. Controlling each indicator 122 independently may enable real time updates to the occupants of the building space. The real time updates may tell the occupants to proceed with caution in a direction during one time period. In a second time period, the real time update may tell the occupants to not proceed in the direction.

Each room in the plurality of rooms may include a room indicator 122. The room indicator 122 may be a mounted device with mono-directional LED lighting. Since the room indicator 122 is mono-directional, the room indictor 122 includes one LED to convey messages and signal to the occupants of the room. For example, the room indicator 122 may have a red color. The red color may indicate a lockdown to the occupants. Each room indicator 122 may correspond to a relay node 126. The relay node 126 may be connected outside of each room and may include a weight to calculate a navigation path.

The ELB 124 may be located inside of the indictor 122. The ELB 124 may improve the strength and quality of the signals transmitted through the CAT6 cabling within the indictor 124. For example, the ELB 124 may include an amplifier to improve the signals transmitted. The ELB 124 may include a signal processing mechanism. The signal processing mechanism may filter any interference and noise that may occur. For example, the ELB 124 may use a signal processing mechanism to remove noise in the signal.

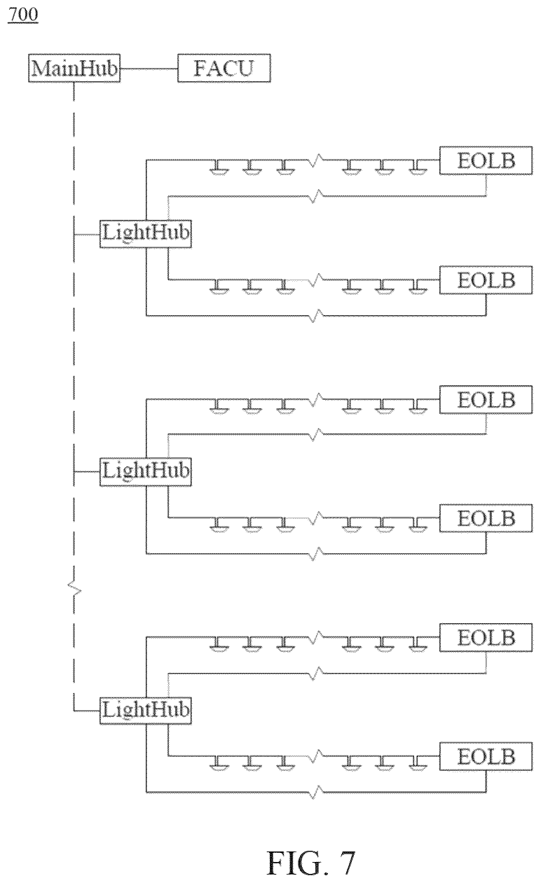

The ELB 124 may determine an integrity for the plurality of cables. The ELB 124 may communicate with the light system 106 to provide cable processor 120 with the integrity of each cable. The ELB 124 may communicate with the light system 106 via the network 102. The ELB 124 may store the integrity information in the system memory 108. In some arrangements, the light system 106 or the main hub 104 may request integrity information from the system memory 108. FIG. 7 illustrates an example schematic 700 of the smart lighting system 100. In the schematic 700, the ELB 124 (e.g., EOLB) can be located at the end of a plurality of nodes 126 along a pathway.

The nodes 126 may be associated with a location within the building space. The nodes 126 may be associated with one or more segments, where each segment of the one or more segments may be located between two nodes 126. The segment may consist of every indicator 122 within the two nodes 126. In some arrangements, all indicators 122 in a segment may be treated as one indicator 126. The segments may have established lengths within the building space. For example, a segment may have a length of 4 meters. In another example, a segment may have a length of 6 meters.

The nodes 126 may include virtual nodes 126. The virtual nodes 126 may be associated with a location and may connect segments. In some arrangements, all of the nodes 126 may be virtual nodes 126 and retain original properties of the nodes 126. The virtual nodes 126 may not be paired with initiating devices. The nodes 126 may include exit nodes 126. The exit nodes 126 may represent an exit or an egress of the building space. The nodes 126 may include room nodes 126. The room nodes 126 may represent the inside of the room in the building space. The room nodes 126 may be assigned a load. The load may correspond to a maximum number of occupants that can be in the room at a given time. The nodes 126 may include relay nodes 126. The relay nodes 126 may be located outside of the room. The nodes 126 may be assigned a weight. The weight may be determined by the event triggered from the node. In some arrangements, a greater weight may indicate a higher level of danger. Neighboring nodes 126 can be a pair of nodes 126 connected to one another via the segment.

The main processor 110 can receive, detect, or otherwise receive a notice of an event from the FACU 116. The notice can be a signal, an indication, a notification, an alarm, an alert, among other types of signals to alert the main hub 104 of the event. The event can correspond to any type of emergency, such as the medical emergencies, environmental emergencies, violence emergencies, public health emergencies, natural disasters, technological emergencies, among other forms of emergencies. For example, the main processor 110 can receive an alert corresponding to an individual who is having cardiac arrest.

The main hub 104 can use the communications unit 112 to communicate with the light system 106. The light system 106 can include a plurality of hubs (e.g., nodes 126) arranged along a plurality of pathways within the building. The plurality of pathways can be within a space of the building to one or more egresses (e.g., exits) of the building. In some instances, the plurality of pathways can be within one or more locations of the building. For example, the plurality of hubs 126 can be arranged along the entrance of the building. Each of the plurality of hubs 126 can include one or more visual indicators 122 to indicate a direction towards an egress or location along one or more of the plurality of pathways. The visual indicators can indicate a direction to avoid based on the event.

The main processor 110 can determine, identify, or otherwise indicate a location of the event using a plurality of sensors at a first time. The location of the event can be within the space of the building, the plurality of pathways, one or more rooms of the building, among other spaces within the building The plurality of sensors can include at least one of smoke detectors, heat sensors, gunshot detectors, pressure sensors, light sensors, air quality sensors, motion sensors, carbon monoxide detectors, gas leak sensors, glass break sensors, current sensors, voltage sensors, humidity sensors, tilt sensors, cameras among others to monitor the building. The main processor 110 can use signals transmitted by each of the plurality of sensors to determine the location of the event. For example, a first temperature sensor on the third floor in the east wing of a building can transmit the signal (e.g., first signal) the main processor 110. Using the signal, based on the location of the temperature sensor, the main processor 110 can determine the location of the event (e.g., fire). As the fire spreads, the main processor 110 can update the location of the event based on a subsequent (e.g., second) signal received from subsequent temperature sensors (e.g., in the west wing, on the second floor, etc.) at a second time. In this manner, the main processor 110 can track the fire as it spreads throughout the building.

In some embodiments, the main processor 110 can determine, identify, or otherwise indicate the location of the event using cameras. The main processor 110 can receive, obtain, or otherwise retrieve a collection of images captured by the plurality of cameras corresponding to the event at a first time. The collection of images can be individual images captured by the camera or a sequence of images as a video captured by the camera. Using the collection of images, the main processor 110 can determine, identify, or otherwise indicate the location of the event. The main processor 110 can analyze the collection of images to obtain distinguishing features of the space within the building. The distinguishing features can correspond to a subset of pixels indicating the location of the event. For example, a subset of pixels can form a sign reading “Restroom” and a sign indicating “IF.” From here, the main processor 110 can identify the location of the event as “The first floor restroom.” In some instances, the main processor 110 can transmit the collection of images to a data center. One or more personnel of the data center can respond with the location of the event.

In some embodiments, At a later time (e.g., second time) the main processor 110 can receive, obtain, or otherwise retrieve a second collection of images corresponding to the event captured by the plurality of cameras. The event can change from a first location to a second location. For example, in a fire emergency (e.g., event), the fire can start in a first space (e.g., cafeteria) of the building (e.g., school) and spread to a second space (e.g., gymnasium). Therefore, the location of the event can change. Using the second collection of images at the later time, the main processor 110 can update the location of the event by analyzing distinguishing features (e.g., signs, words, objects, etc.) of each image in the collection of images.

The main processor 110 can determine, identify, or otherwise generate a type for the event. The type for the event can correspond to or derive from the event. For instance, if the event is a medical emergency, the type for the event can indicate a cardiac arrest, an allergic reaction, traumatic injury, choking, stroke, flesh wounds, among other forms of medical emergency. In another instance, if the event is a natural disaster, the type for the event can indicate an earthquake, a flood, a hurricane, a tornado, a wildfire, among other forms of natural disaster. In yet another instance, if the event is a violence emergency, the type for the event can indicate an active shooter, a terrorist attack, a bomb threat, a kidnapping, a hostage situation, a riot, among other forms of violence emergency. The main processor 110 can use signals received from the plurality of sensors at the first time to identify the type for the event. For example, the main processor 110 can receive signals from a plurality of gunshot detectors. Therefore, the main processor 110 can identify the type for the event as a “shooting” based on the signal.

The main processor 110 can determine, identity, or otherwise generate one or more navigation paths along the plurality of pathways within the building space. The one or more navigation paths can indicate a direction for one or more persons to navigate to the egress or location of the building based on the location of the event and the type of the event. The one or more navigation paths and the direction can be different based on the location of each of the one or more persons. For example, the one or more navigations paths for a first person on an cast wing of the building can be different for the one or more navigation paths for a second person in the center of the building. To determine the one or more navigation paths, the main processor 110 can execute a SEA * algorithm (described herein) to calculate an optimal navigation paths for each person or each group of persons in the one or more persons.

The main processor 110 can trigger, cause, or otherwise prompt the light system 106 to generate, create, or otherwise identify a signal indicating the type for the event, the location of the event, and the one or more navigation paths in the direction toward the egress or the location of the building. The light system 106 can transmit the signal to one or more hubs 126 of the plurality of hubs 126. The signal can cause the one or more hubs 126 to provide one or more visual indicators 122 according to the type for the event, the location of the event, and the one or more navigation paths in the direction toward the egress or the location of the building. The one or more visual indicators 122 can display a plurality of colors on a subset of the one or more hubs to convey a message to the one or more persons. For instance, the one or more visual indicators 122 of a first subset of hubs 126 can display red to indicate that there is danger along the navigation path, whereas the one or more visual indicators 122 of a second subset of hubs 126 can display green to indicate that the one or more persons are to proceed along the navigation path.

In some instances, the main processor 110 can receive, retrieve, or otherwise obtain an indication of an arrival of authorized personnel (e.g., emergency medical services, police, firefighters, etc.) within the building. For example, the authorized personnel can interact with a user interface of the main hub 104 for authorization (e.g., badge, pin, password, etc.). Upon reception of the indication, the main processor 110 can trigger, cause, or prompt the light system 106 to generate a signal indicating the arrival of the authorized personnel. The light system 106 can transmit the signal to each of the plurality of hubs 126 causing the hubs to provide one or more visual indicators 122 to indicate the arrival of the authorized personnel.

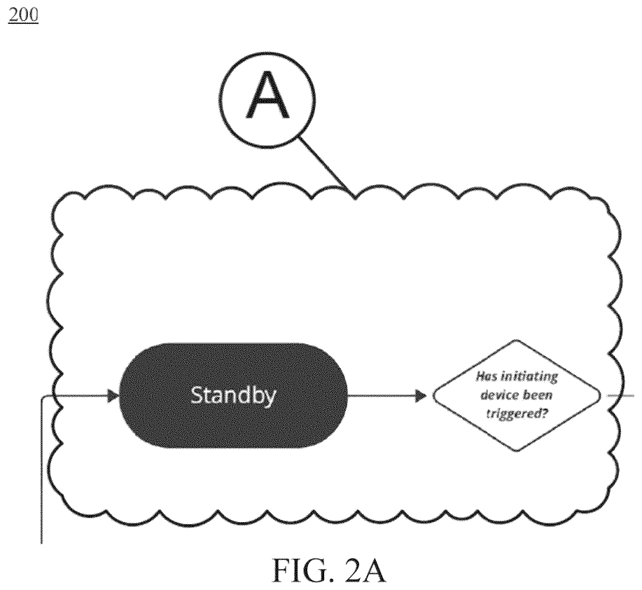

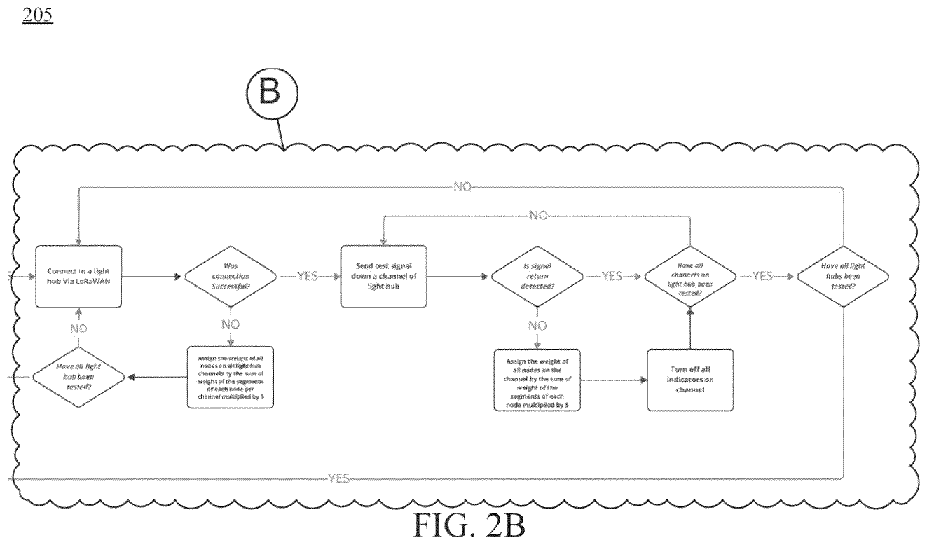

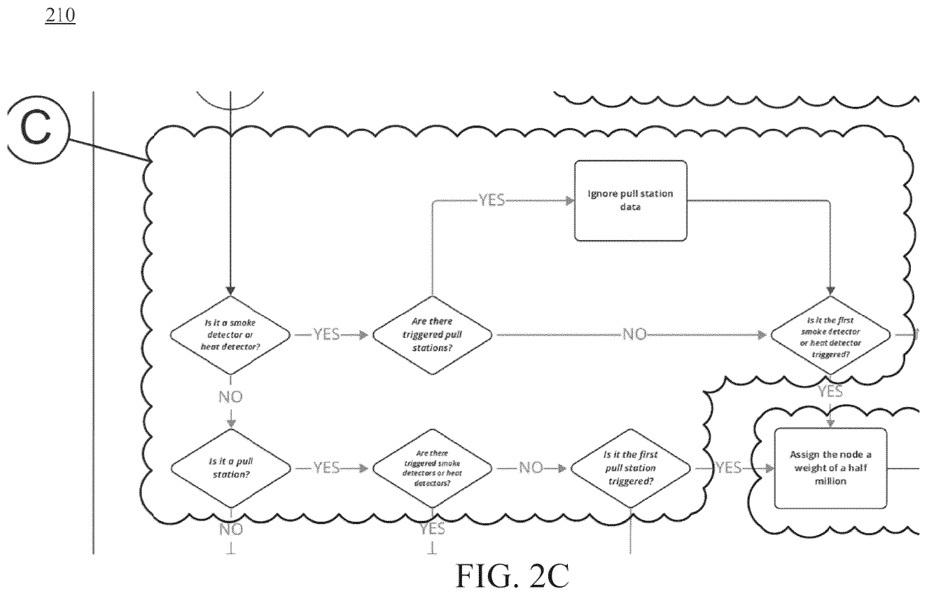

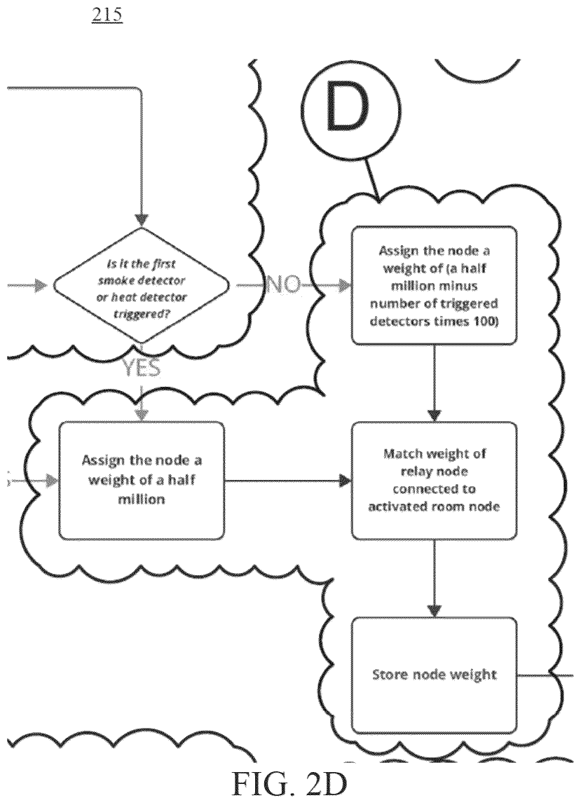

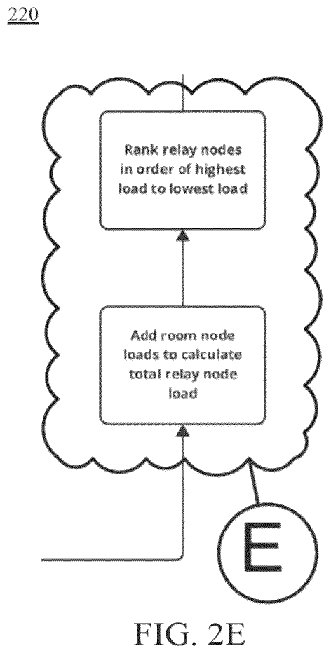

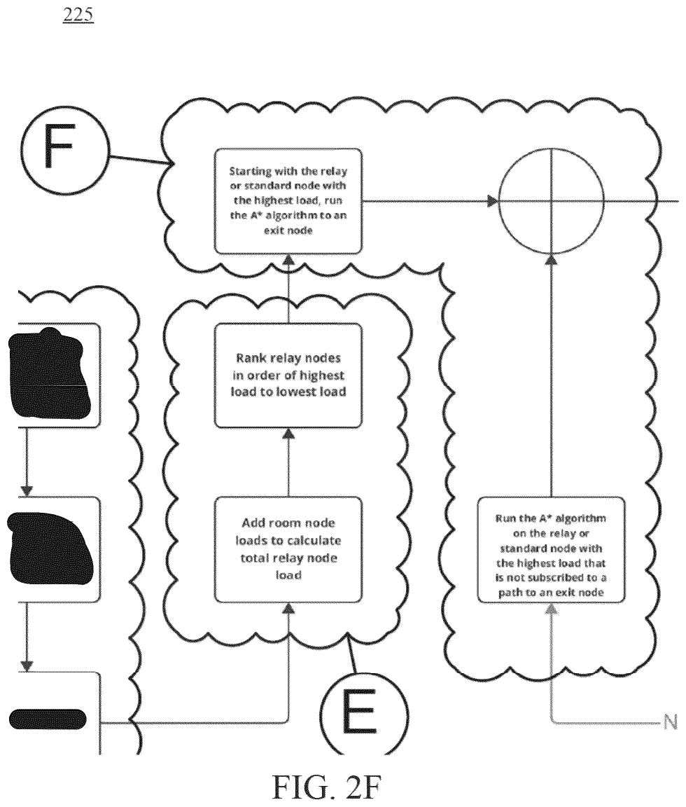

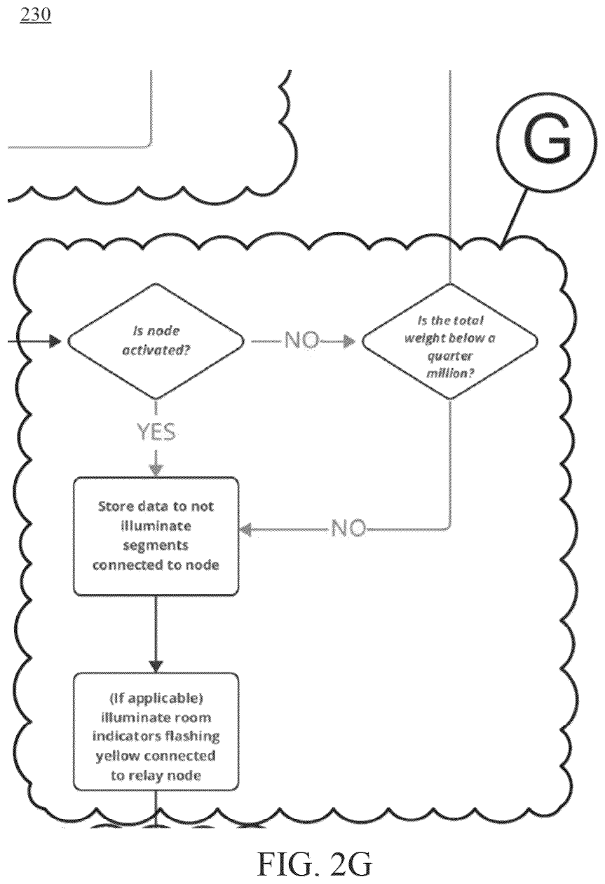

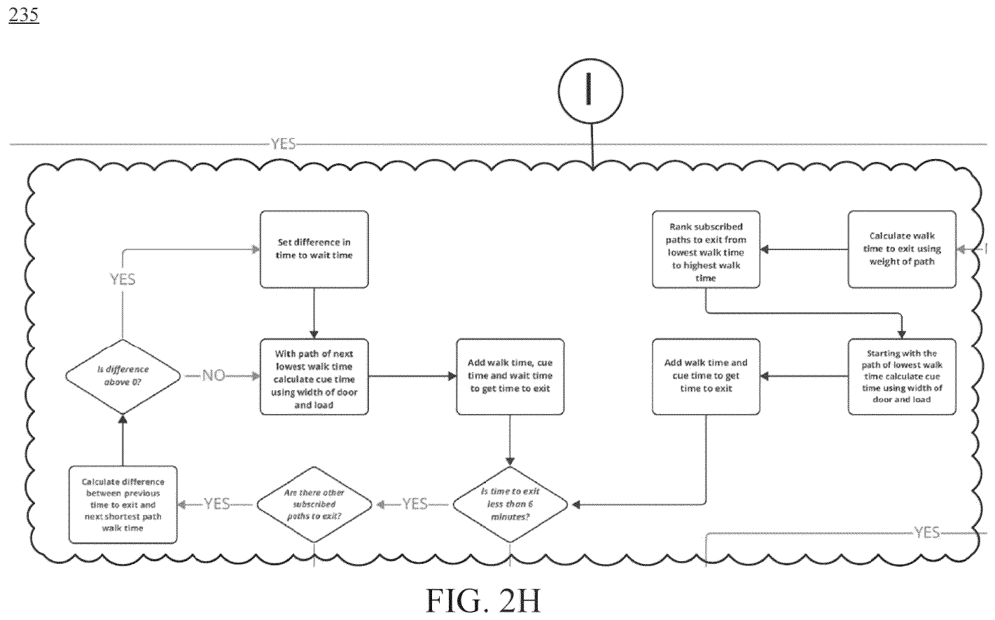

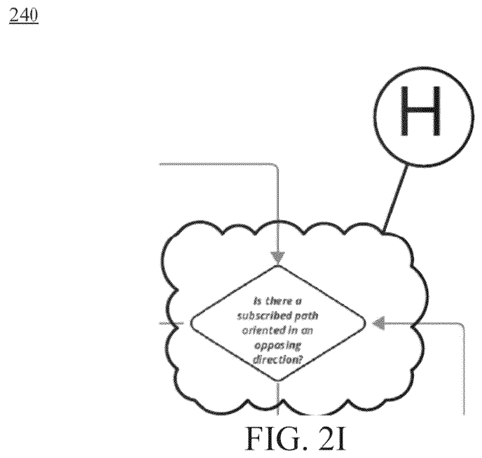

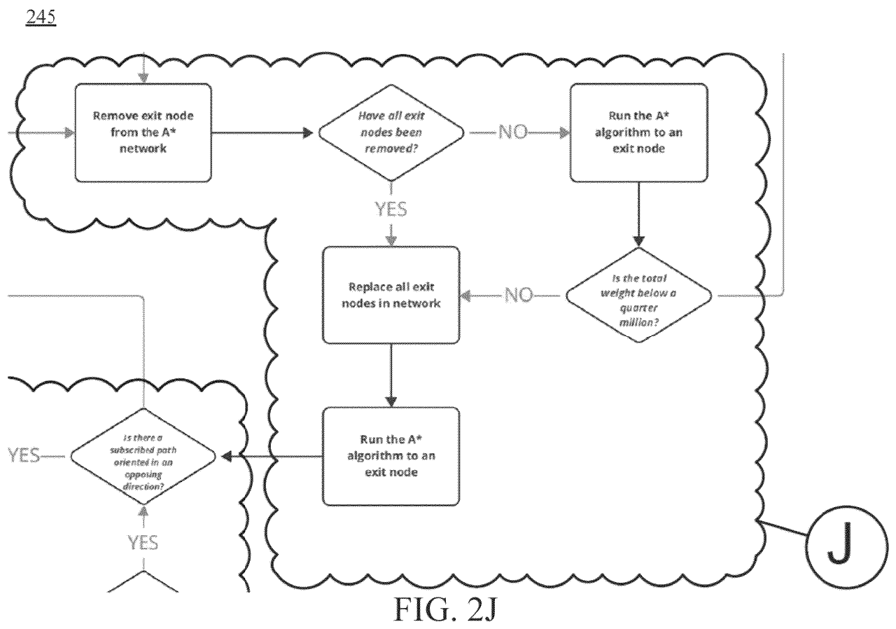

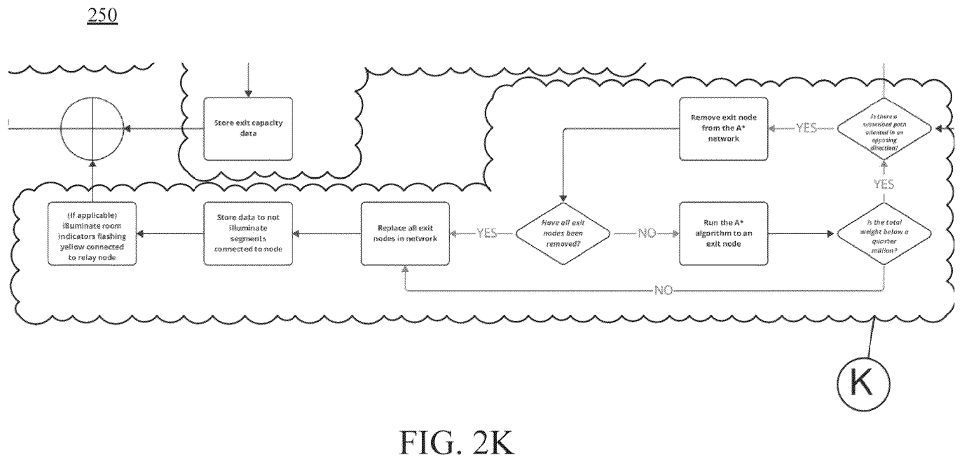

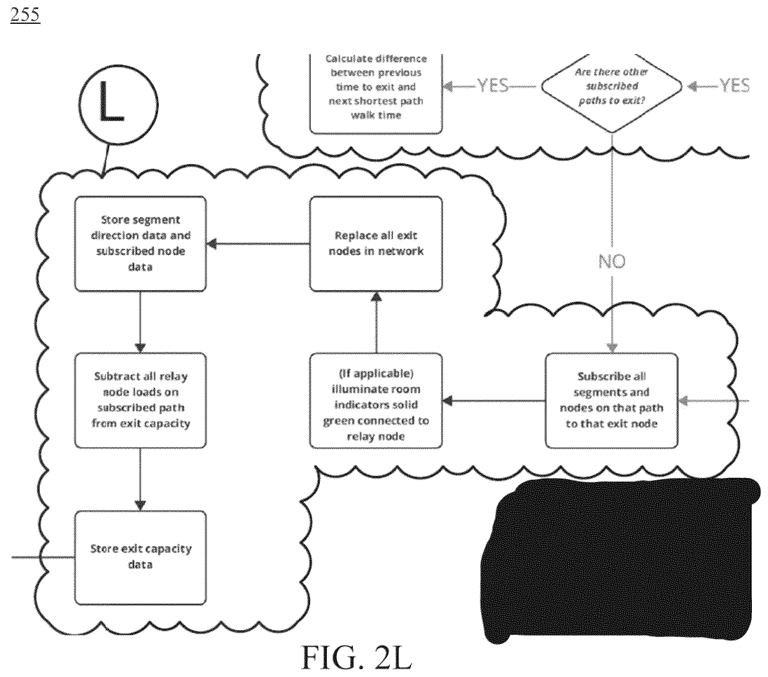

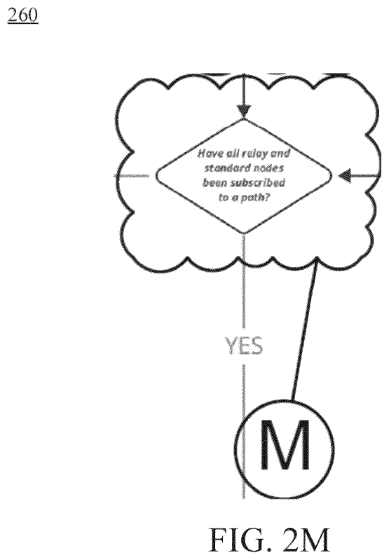

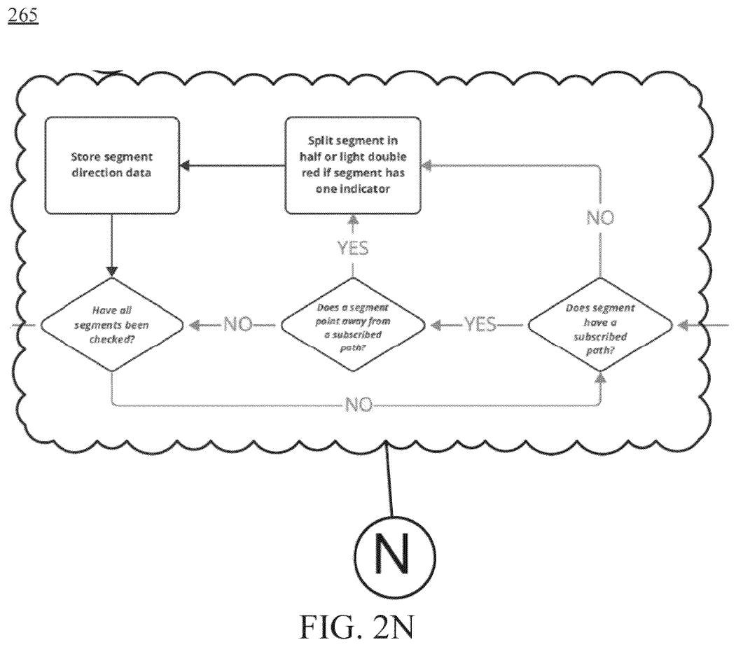

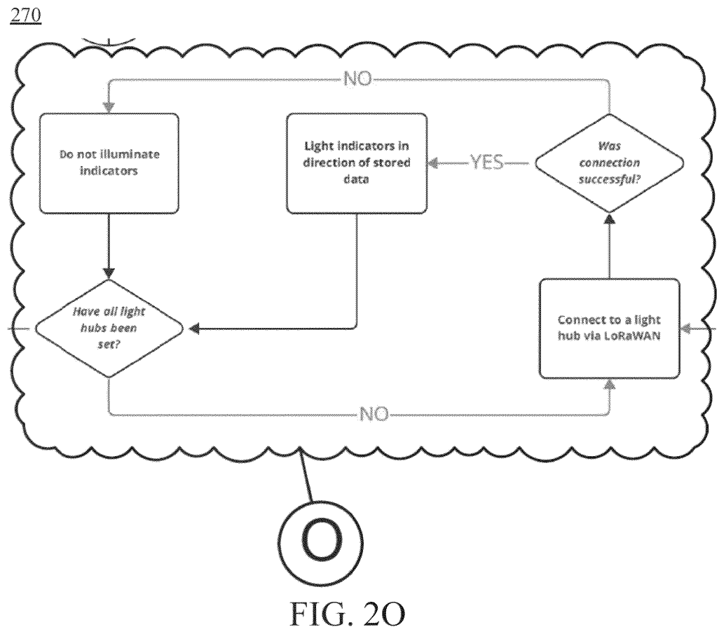

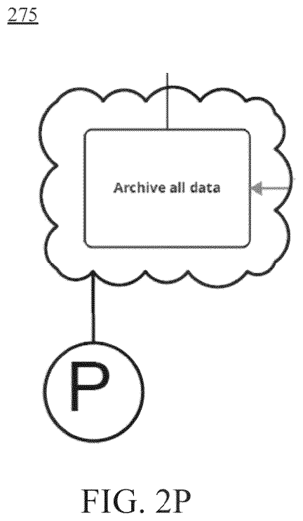

FIGS. 2A-2P illustrates a flow diagram of a method 200 executed in the smart lighting system 100. The example system 100 can perform the method 200 (referred to as the SEA* Algorithm) according to present implementations. It is to be appreciated that additional, fewer, or different operations (e.g., steps, substeps, etc.) than what is described herein may be performed depending on the particular arrangement. In some embodiments, some, or all operations of method 200 may be performed by a computing system (e.g., main hub 104, system 100) executing on one or more processors, systems, or servers. In various embodiments, each operation may be re-ordered, added, removed, or repeated.

The SEA* Algorithm can be a pathfinding algorithm that employs the A* Algorithm which can use a map of nodes 126 and segments to find the safest path (e.g., one or more navigation paths) between a start node 126 and an end node 126. The SEA* Algorithm can assign weights to given nodes 126. Therefore, traveling to a node 126 may impact the total path weight. The weight of each segment can match the physical distance of the pathway it represents. For example, if a pathway is 10 ft long, the segment in the SEA* Algorithm that corresponds to that pathway can get a weight of 10. Nodes 126 are placed in many different areas of the building and there are a few different types of nodes 126. For example, a standard node 126 is in all pathways and corridors in the building space and corresponds to a smoke detector in that pathway or corridor. The weight of each node 126 corresponds to whether that detector is activated or not. Under non-activated conditions, the weight of the node 126 (e.g., smoke detector) is 0. Under activated conditions the weight of the node 126 (e.g., smoke detector) is increased significantly (e.g., half a million). The SEA* Algorithm can find an alternate path because any other path is likely to be less than a half a million. Once the SEA* Algorithm has found a path the smart lighting system perform a check to see if the total weight of the path is less than a quarter million. If the weight of the path is over a quarter million, the smart lighting system are traveling through an activated node, and that path should not be taken.

The smart lighting system runs the SEA* Algorithm from every standard and relay node 126 to any exit node 126 (e.g., quickest/safest exit node). Therefore, the smart lighting system in its totality can run the SEA* Algorithm up to several hundred times in the time frame of a fraction of a second to calculate paths for everyone in the building. The SEA* Algorithms may take the quickest path from A* Algorithm and ensure that the quickest path is the safest path. The smart lighting system can examine if there is a fire on the path, how many occupants are being sent to each exit, if there are other dangers on the path, if there are there broken lights on the path, etc.

The smart lighting system can be used for fire emergencies within a building space. Fire emergencies can include at least one of fire, smoke, heat, or carbon monoxide detection, among others. Method 200 can be used to decide which indicators (e.g., indicators 122) can illuminate green and which indicators can illuminate red. Occupants in the building space can follow the green lights whereas firefighters can follow the red lights. The method 200 may begin from a fire alarm initiating device (e.g., smoke detector, heat detector, manual pull station, etc.) from a fire alarm control unit (e.g., FACU 116). The FACU can connect to the main hub and the main hub can process data to send signals to a light system (e.g., light system 106). The light system can send signals to each indicator with information of which way the indicators can illuminate green and which way they can illuminate red.

Referring now to FIG. 2A, at block A, the smart lighting system can be on standby for a fire alarm initiating device to be triggered. Referring now to FIG. 2B, at block B, the smart lighting system can connect to the light system to verify cable integrity and wiring connections. The smart lighting system can identity, determine, otherwise detect a first subset of nodes 126 that do not satisfy a threshold (e.g., broken, burned, faulty) causing a failure to connect to the light system and a second subset of nodes 126 that satisfy the threshold. The smart lighting system, can assign, indicate, or otherwise include a plurality of weights for each of the plurality of nodes 126. The weights assigned to the first subset of the plurality of nodes 126 can be lower than weights assigned to the second subset of the plurality of nodes 126. If there is a failure to connect to the light system or there is broken, burned, or faulty cable detected, the smart lighting system may decrease the weight of one or more nodes (e.g., nodes 126) connected to the faulty cable. The smart lighting system can determine the one or more navigation paths according to the weights assigned to each of the plurality of nodes 126. The SEA* Algorithm may not proceed down a path with faulty or broken indicators. Referring now to FIG. 2C, at block C, the smart lighting system can identify whether the activated initiating device is a smoke/heat detector or a pull station. The credibility of a smoke/heat detector is significantly higher than the credibility of a pull station so once a smoke/heat detector has been activated, the smart lighting system ignores data from pull stations. The smart lighting system considers the first pull station activated and if there is a detector activated after, the smart lighting system ignores all pull station data.

Referring now to FIG. 2D, at block D, the smart lighting system can determine a first activated heat/smoke detector (e.g., node 126) activated in response to the notice of the event. The smart lighting system can assign a weight to a first activated heat/smoke detector. The first activated fire/smoke detector receives a weight of half a million (e.g., maximum weight). All subsequent smoke/heat detectors get a diminishing weight. The diminishing weight is calculated by doing (half a million−a number of triggered detectors*100. The smart lighting system calculates the diminishing weight because smoke and heat can spread faster than the actual fire and the smart lighting system can prioritize avoiding fire. If there is a fire in a room the smart lighting system may match the weight of the room node 126 to the relay node 126 located outside of the room in the pathway. Therefore, the smart lighting system can determine the one or more navigation paths according to the weights assigned to each node 126 and the maximum weight assigned to the first node 126

Referring now to FIG. 2E, at block E, for each relay node, the smart lighting system adds all the room loads (number of occupants in each room) that are linked to that relay node 126 to get a total relay node 126 load. Then the smart lighting system can rank all the relay nodes by their load number (number of occupants) from highest to lowest. When the smart lighting system runs the SEA* Algorithm, the smart lighting system can serve areas with a plurality of occupants first, because those areas can be most restrictive on what doors can support all the occupants. Referring now to FIG. 2F, at block F, the smart lighting system can employ the A* Algorithm, on the standard node 126 or relay node 126 of the highest load that has not already been subscribed to a path, to an exit node. This can result in the quickest path to an exit from the starting node 126 and run for every standard node 126 and relay node 126 in building.

Referring now to FIG. 2G, at block G, the smart lighting system can check to see if the A* Algorithm found a path that is not through an activated detector. If the path does go through an activated detector the smart lighting system may not illuminate the lights on the segments connected to that node. The smart lighting system can flash a yellow light in rooms that are linked to a relay node 126 if applicable signaling to be cautious while evacuating.

Referring now to FIG. 2H, at block H, the smart lighting system can check to see if the path the SEA* Algorithm found points in an opposing direction to an already subscribed path. The subscribed path is an assigned a direction the SEA* Algorithm if a segment can illuminate and can span multiple nodes and segments. The subscribed path can be a path of travel determined by the SEA* Algorithm from any given node to an exit node. The smart lighting system can ensure all segments are only pointing in one direction so there is no congestion in the pathways and corridors which can cause confusion. If there is a path in an opposing direction the smart lighting system may re-run the SEA* Algorithm which removes the previously found exit node 126 from eligible exit nodes 126.

Referring now to FIG. 2I, at block I, the smart lighting system can determine the total time to exit building using the path by determining a number of occupants assigned to each exit and which groups of occupants can get there first. The SEA* Algorithm factors in the amount of time it takes to get to the exit and the time it takes to get through the door. The SEA* Algorithm further factors in the size of the door and how many occupants can exit through a particular door per minute. If the time to exit the building is more than six minutes or the number of occupants exceed a threshold, the smart lighting system may re-run the SEA* Algorithm which removes the previously found exit node 126 from eligible exit nodes 126 to identify a second exit node 126. If no other exit is available, the SEA* Algorithm can default back to the originally assigned exit referred to as basic crowd control. The smart lighting system may not send everyone in the building to the same door as that can cause congestion.

Referring now to FIG. 2J, at block J, the smart lighting system can re-run SEA* Algorithm which removes the previously found exit node 126 from eligible exit nodes if the time to exit is over six minutes or there is a path in an opposing direction. The smart lighting system may keep removing exits until a viable exit is found or all exits have been removed.

Referring now to FIG. 2K, at block K, the smart lighting system can replace all exits and run the SEA* Algorithm one last time to default back to the originally assigned exit in the case that the total time to exit the building is over six minutes. If the smart lighting system runs the SEA* Algorithm again and the weight is over a quarter million or there is a subscribed path in an opposing direction, the visual indictors may not illuminate the lights on the segments connected to that node. The smart lighting system may flash a yellow light in rooms that are linked to a relay node 126 if applicable signaling to be cautious while evacuating.

Referring now to FIG. 2L, at block L, the smart lighting system can subscribe all the segments and nodes on a path to an exit (e.g., saves data), so the smart lighting system may not have to run the SEA* Algorithm on standard nodes that already have paths passing through them. The smart lighting system may illuminate a solid green light in rooms that are linked to a relay node 126 signaling that the relay node 126 is safe to exit. Referring now to FIG. 2M, at block M, the smart lighting system can check if all standard and relay nodes have been subscribed to an exit. If not, the smart lighting system 100 can run the SEA* Algorithm, on the standard node 126 or relay node 126 of the highest load that has not already been subscribed to a path, to an exit node.

Referring now to FIG. 2N, at block N, the smart lighting system can check for loops of green lights and break them if applicable, so that the smart lighting system does not lead occupants in a continuous loop around the building space. Referring now to FIG. 2O, at block O, the smart lighting system can connect to all the light systems and send the signal to illuminate all indicators from the stored data. Referring now to FIG. 2P, at block P, the smart lighting system may save all data (e.g., in system memory 108) for future use or investigation by storing, maintaining, or otherwise housing an association between the type of the event and the one or more navigation paths to the egress or location of the building.

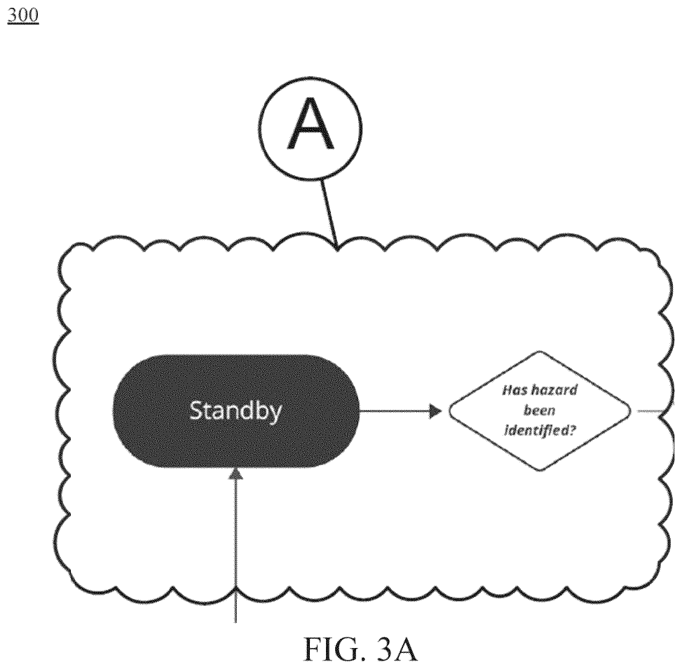

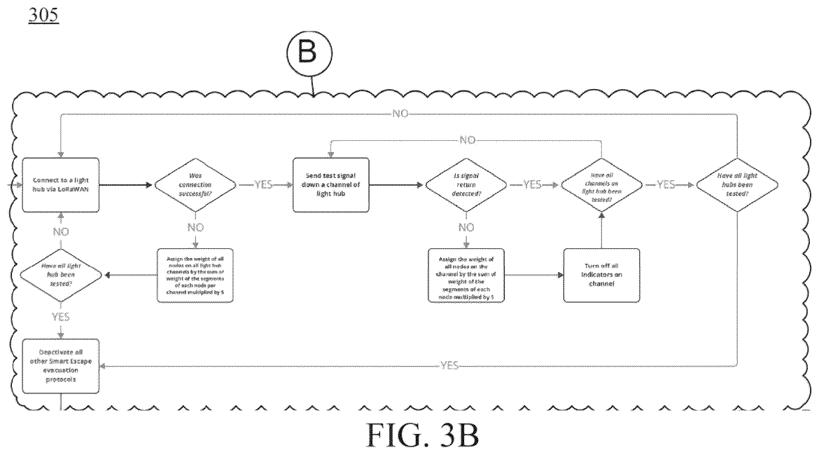

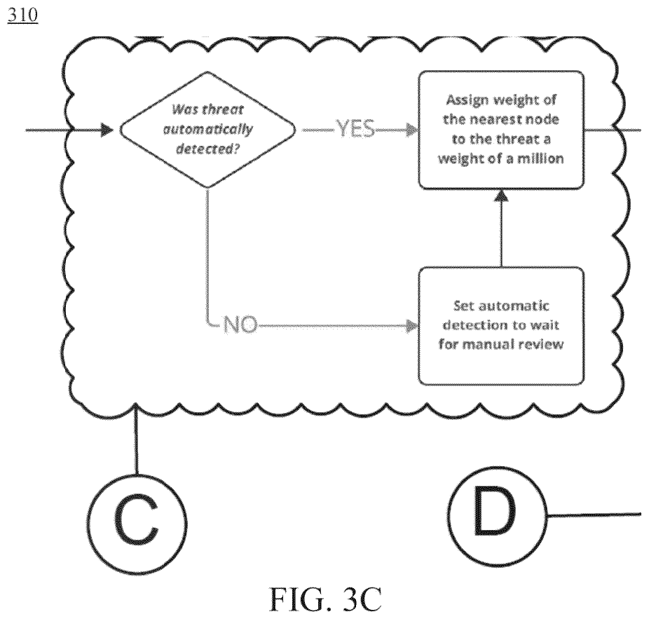

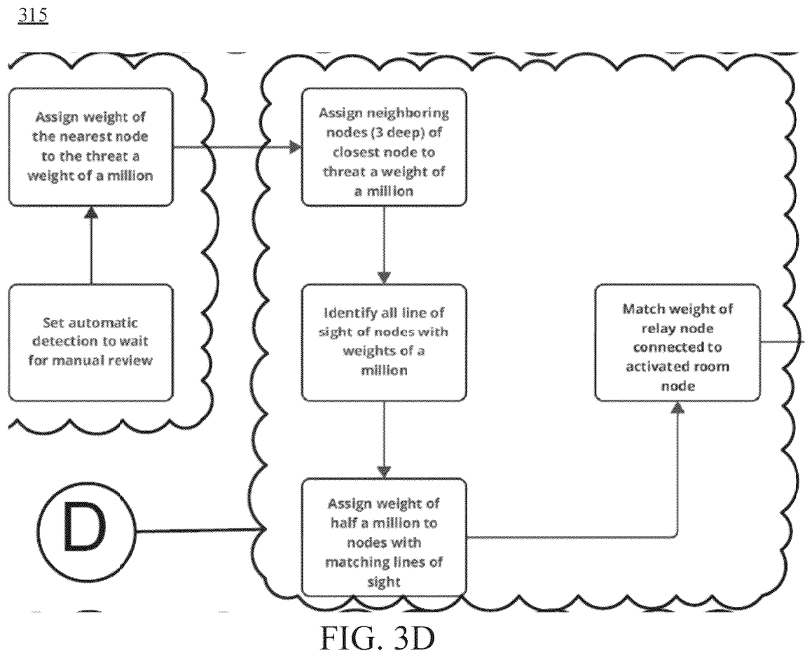

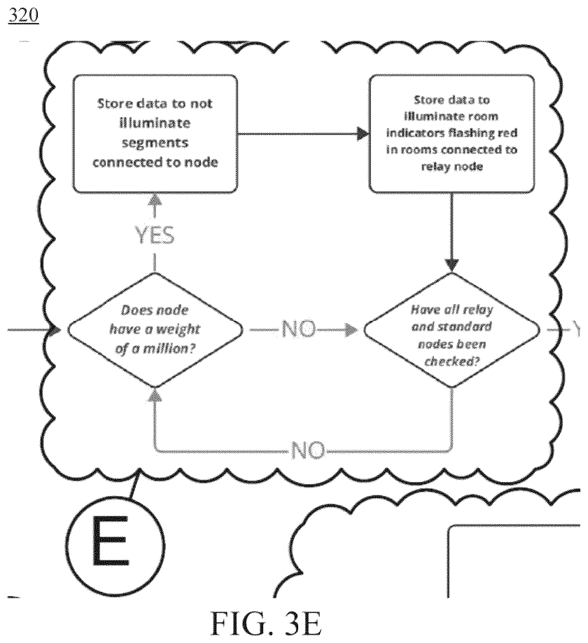

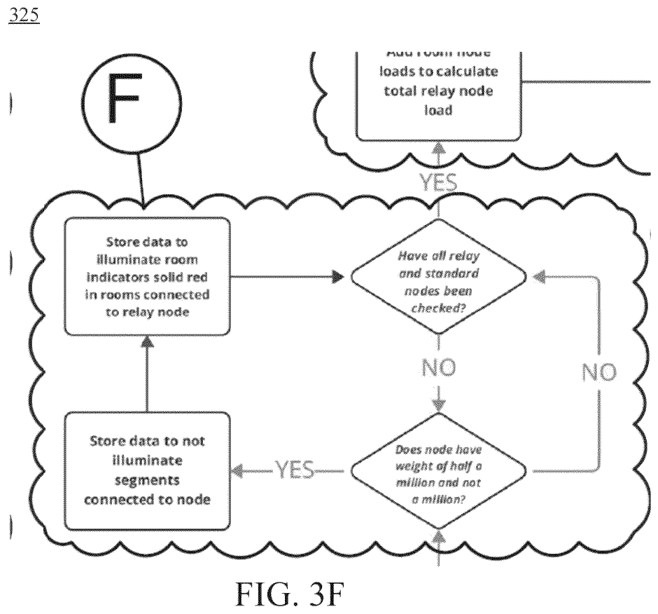

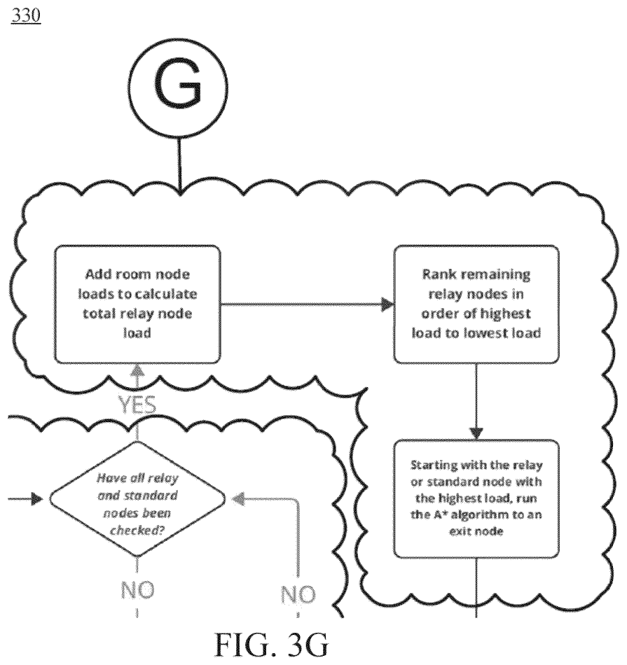

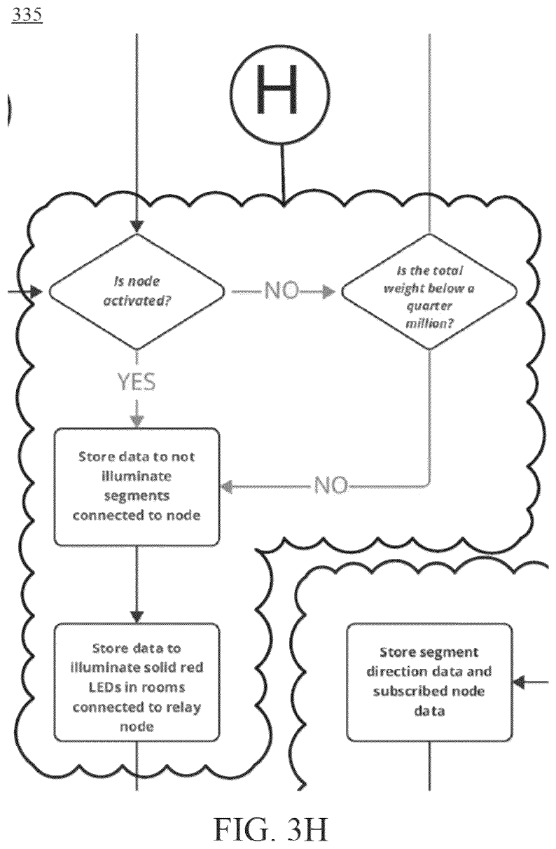

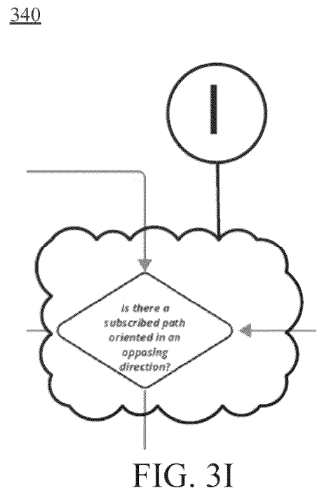

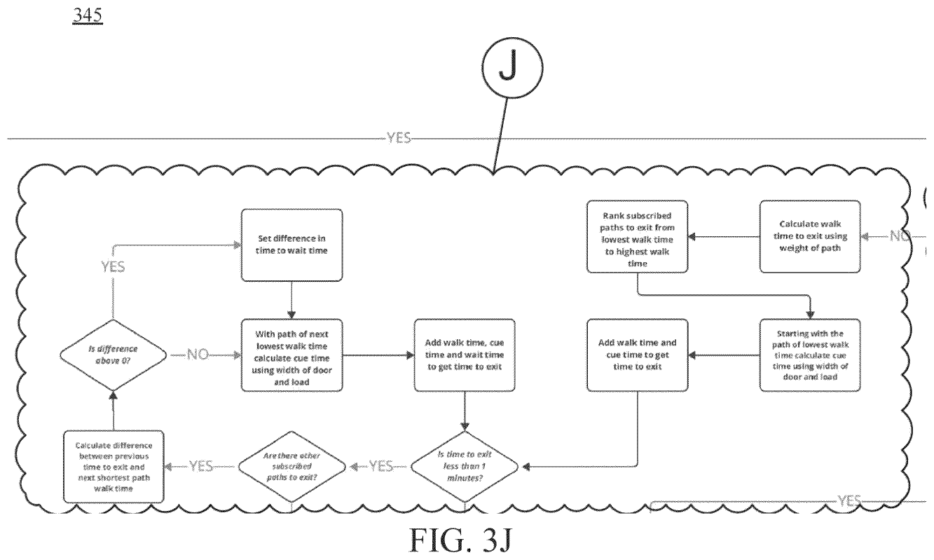

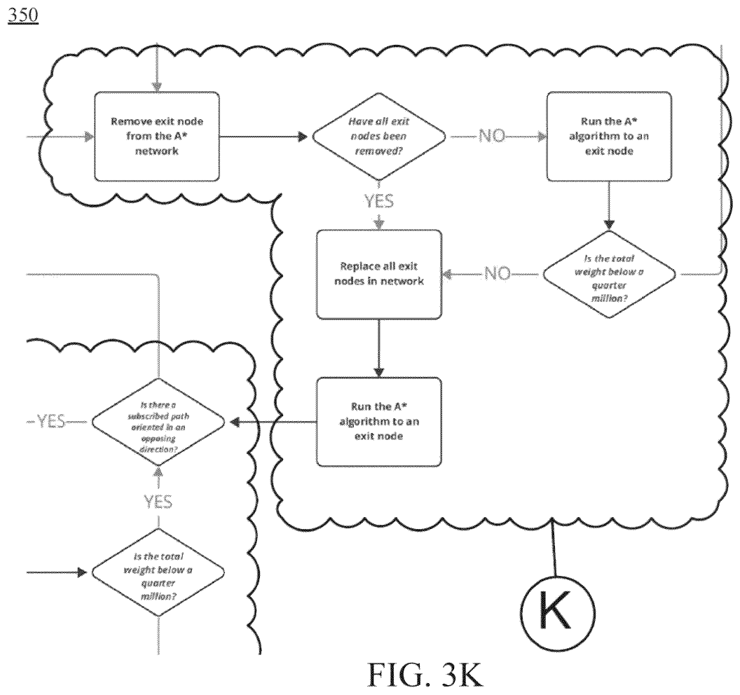

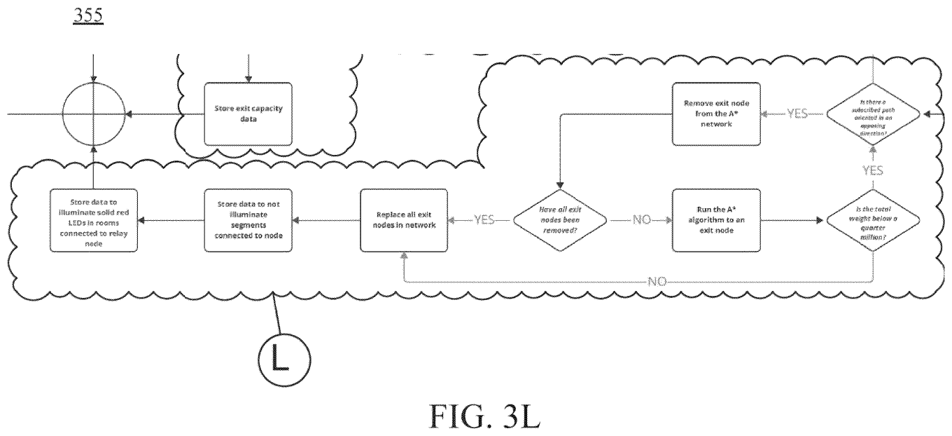

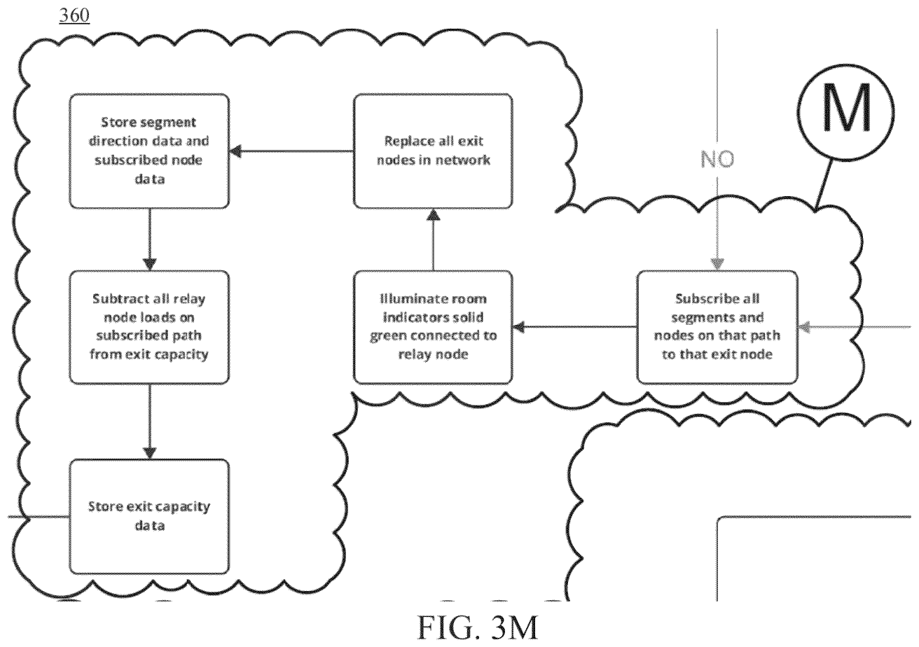

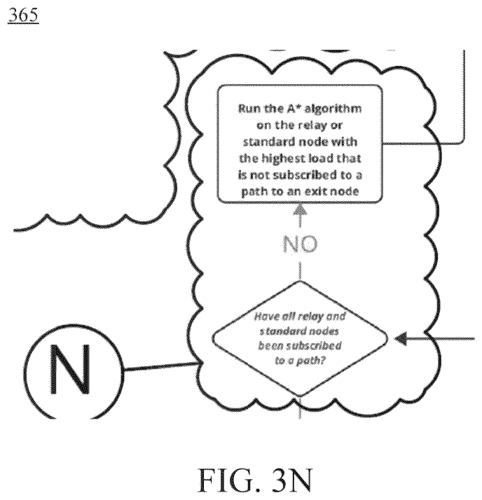

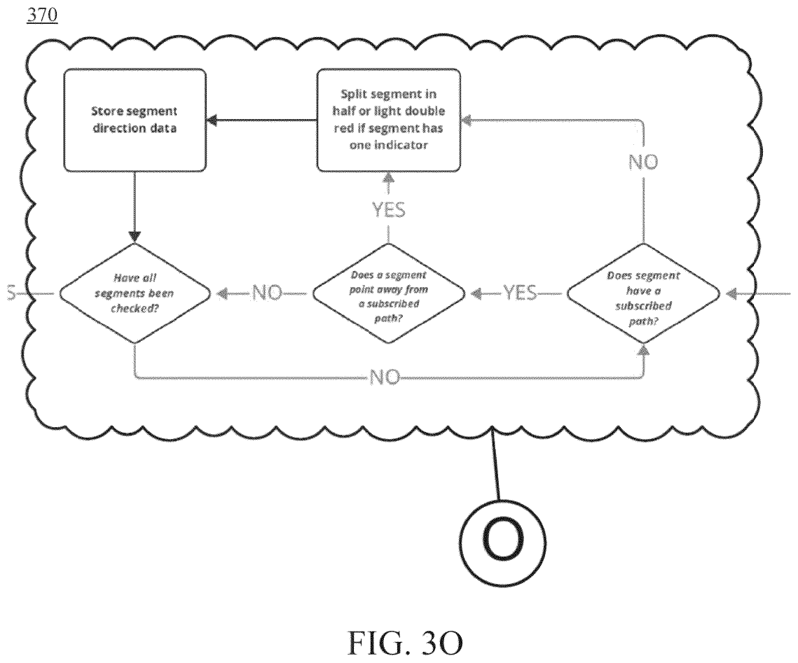

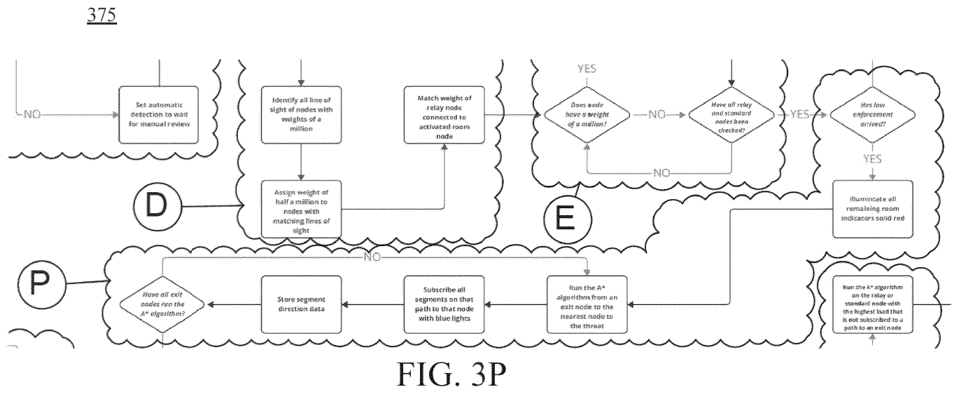

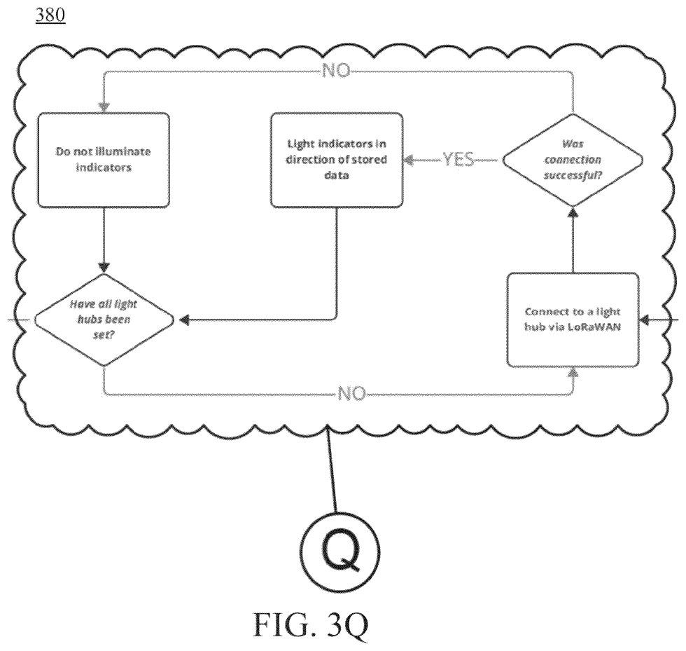

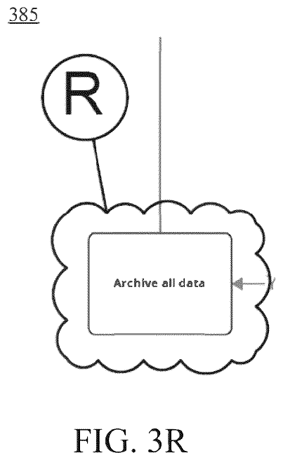

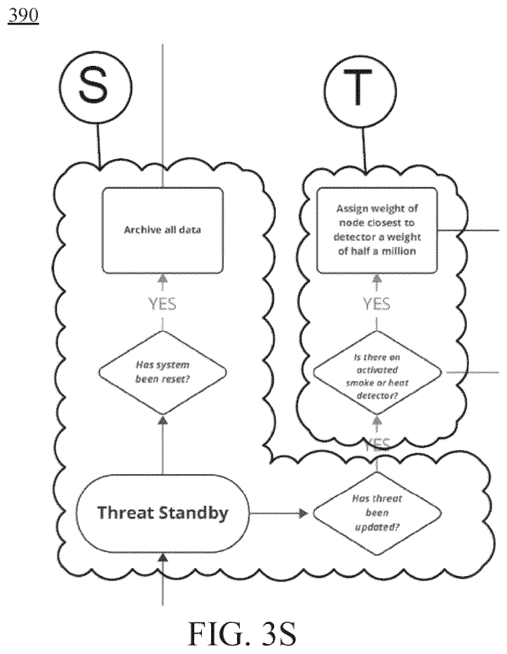

FIGS. 3A-3S illustrates a flow diagram of a method 300 executed in the smart lighting system 100. The example system 100 can perform the method 300 (referred to as the SEA* Algorithm) according to present implementations. It is to be appreciated that additional, fewer, or different operations (e.g., steps, substeps, etc.) than what is described herein may be performed depending on the particular arrangement. In some embodiments, some, or all operations of method 300 may be performed by a computing system (e.g., main hub 104, system 100) executing on one or more processors, systems, or servers. In various embodiments, each operation may be re-ordered, added, removed, or repeated.

The smart lighting system can be used for lockdown emergencies (e.g., a threat, shooter, or intruders, among others). Occupants who are evacuating follow the green lights, which can bring the occupants to an exit, and the red lights show unsafe paths. Method 300 may be activated by automatic methods such as gunshot detectors and automatic cameras, or manual methods such as using an electronic interface in a central command center. The gunshot detectors detect and convey the location of gunfire using acoustic, vibration, optical, or potentially other types of sensors. When a threat has been identified, the main hub processes the data with the SEA* Algorithm shown in the method 300 and then sends signals to a light system (e.g., light system 106) with information of which way the indicators (e.g., indicators 122) can illuminate green and which way they can illuminate red. Once law enforcement has arrived, an authorized person may manually activate a secondary mode which illuminate blue lights starting at every exit and ending at the location of the threat. This leads law enforcement directly to the threat. Method 300 of the SEA* Algorithm may take priority over other methods (method 200, method 400, method 500, etc.) described herein and can interrupt any other methods when activated. The system can stay activated until a reset signal is sent through the main hub 104 interface.

Referring now to FIG. 3A, at block A, the smart lighting system can be on standby waiting for a hazard activation. Referring now to FIG. 3B, at block B, the smart lighting system can include connecting to the light system to verify cable integrity and wiring connections. The smart lighting system can identity, determine, otherwise detect a first subset of nodes 126 that do not satisfy a threshold (e.g., broken, burned, faulty) causing a failure to connect to the light system and a second subset of nodes 126 that satisfy the threshold. The smart lighting system, can assign, indicate, or otherwise include a plurality of weights for each of the plurality of nodes 126. The weights assigned to the first subset of the plurality of nodes 126 can be lower than weights assigned to the second subset of the plurality of nodes 126. If there is a failure to connect to the light system or there is broken, burned, or faulty cable detected, the smart lighting system may decrease the weight of one or more nodes (e.g., nodes 126) connected to the faulty cable. The smart lighting system can determine the one or more navigation paths according to the weights assigned to each of the plurality of nodes 126. The SEA* Algorithm may not proceed down a path with faulty or broken indicators.

Referring now to FIG. 3C, at block C, the smart lighting system can determine if the threat was automatically detected or if the threat was manually detected. Automatic detection is done through the use of gunshot detectors and automatic cameras. Manual detection is done by using an electronic interface in a central command center. A priority is given to manual detection as it is significantly more reliable than automatic detection. The nearest node 126 to the threat is assigned a weight of a million.

Referring now to FIG. 3D, at block D, the smart lighting system can assign nodes that are three nodes or fewer away from the activated node 126 to a weight of half a million (e.g., maximum weight). The smart lighting system can create a zone around the threat that is in imminent danger. The smart lighting system can identify all lines of sight with any of the nodes with a weight of a million and assign them a weight of a half a million. If the threat has a ranged weapon, such as a firearm, it can be dangerous at any distance if there is a line of sight. The line of sight can be one or more locations visible to the threat. The nodes 126 within the line of sight can share an identifier with the node 126 closest to the threat. Furthermore, if there is a threat in a room the smart lighting system may match the weight of the room node 126 to the relay node 126 located outside of the room in the pathway.

Referring now to FIG. 3E, at block E, the smart lighting system can check if a room is connected to a relay node 126 that has a weight of a million, indicating that the room is in immediate danger. The smart lighting system may not illuminate any lights on the segments connected to the relay node 126 and the smart lighting system can illuminate a flashing red light in the room signaling to barricade the door and prepare to fight and can be checked for every relay node.

Referring now to FIG. 3F, at block F, the smart lighting system can check if a room is connected to a relay node 126 that has a weight of a half a million. Therefore, a node with a weight of half a million is in the line of sight of the threat. The smart lighting system may not illuminate any lights on the segments connected to the relay and the smart lighting system can illuminate a solid red light in the room signaling to lock the door and hide and can be checked for every relay node.

Referring now to FIG. 3G, at block G, the smart lighting system can add all the room loads (e.g., number occupants in each room) that are linked to that relay node 126 to get a total relay node 126 load. Then the smart lighting system can rank all the relay nodes 126 by their load number (e.g., number of occupants) from highest to lowest. When the smart lighting system runs the SEA* Algorithm, the smart lighting system can serve areas with a plurality of occupants first, because those areas can be most restrictive on what doors can support all the occupants. The smart lighting system can employ the A* Algorithm, on the standard or relay node 126 of the highest load that has not already been subscribed to a path, to an exit node 126.

Referring now to FIG. 3H, at block H, the smart lighting system can check to see if the A* Algorithm found a path that is not through an activated detector. If the path does go through an activated detector, the smart lighting system may not illuminate the lights on the segments connected to that node 126. The smart lighting system may illuminate a solid red light in rooms that are linked to a relay node 126 signaling to lockdown and hide.

Referring now to FIG. 3I, at block I, the smart lighting system can check to see if the path the A* Algorithm found, points in an opposing direction to an already subscribed path. The smart lighting system may ensure that all segments are only pointing in one direction so there is no congestion in the pathways and corridors which can cause confusion. If there is a path in an opposing direction the smart lighting system may re-run the SEA* Algorithm which removes the previously found exit node 126 from eligible exit nodes 126.

Referring now to FIG. 3J, at block J, the smart lighting system can determine the total time to exit building using the path by determining a number of occupants assigned to each exit and which groups of occupants can get there first. The smart lighting system factors in the amount of time it takes to get to the exit and the time it takes to get through the door, the size of the door, and how many occupants can exit through a particular door per minute. If the time to exit the building is more than one minute or the number of occupants exceed a threshold, the smart lighting system re-runs the SEA* Algorithm which removes the previously found exit node 126 from eligible exit nodes to identify a second exit node 126. If no other exit is available, it can default back to the originally assigned exit so that the smart lighting system does not send everyone in the building space to the same door as that can cause congestion.

Referring now to FIG. 3K, at block K, the smart lighting system may re-run the SEA* Algorithm which removes the previously found exit node 126 from eligible exit nodes 126 if the time to exit is over one minute or there is a path in an opposing direction. The smart lighting system can keep removing exits until a viable exit is found or all exits have been removed. Referring now to FIG. 3L, at block L, the smart lighting system can replace all exits and run the SEA* Algorithm one last time to default back to the originally assigned exit in the case that the total time to exit the building is over one minute. If it runs the SEA* Algorithm again and the weight is over a quarter million or there is a subscribed path in an opposing direction it can not illuminate the lights on the segments connected to that node. The smart lighting system may illuminate a solid red light in rooms that are linked to a relay node 126 signaling to lockdown and hide.

Referring now to FIG. 3M, at block M, the smart lighting system can subscribe all the segments and nodes on a path to an exit (saves data). The subscription is done so that the smart lighting system may not have to run the SEA* Algorithm on standard nodes that already have paths passing through them. The smart lighting system may illuminate a solid green light in rooms that are linked to a relay node 126 signaling that it is safe to exit. Referring now to FIG. 3N, at block N, the smart lighting system can check if all standard and relay nodes have been subscribed to an exit. If not, it can run the SEA* Algorithm, on the standard or relay node 126 of the highest load that has not already been subscribed to a path, to an exit node. Referring now to FIG. 3O, at block O, the smart lighting system can check for loops of green lights and break them if applicable. This is done so that the smart lighting system does not lead occupants in a continuous loop around a building space.

Referring now to FIG. 3P, at block P, once law enforcement arrives, an authorized person can manually activate a new node and remaining room lights that are not flashing red can illuminate solid red. The SEA* Algorithm may run starting at an exit node 126 and ending at the node 126 closest to the threat and is repeated for every exit. Once all exits have been subscribed to a path, the lights are illuminated with blue instead of green to signal law enforcement to follow them towards the threat. Referring now to FIG. 3Q, at block Q, the smart lighting system can connect to light system and send signals to illuminate all indicators from the stored data. Referring now to FIG. 3R, at block R, the smart lighting system can save all data (e.g., in system memory 108) for future use or investigation by storing, maintaining, or otherwise housing an association between the type of the event and the one or more navigation paths to the egress or location of the building.

Referring now to FIG. 3S, at block S, after the SEA* Algorithm completes execution, the smart lighting system may not return to the original standby and enters threat standby. The threat standby may maintain a functioning loop without entering the original standby. The SEA* Algorithm waits for an authorized signal to reset the system and blocks the smart lighting system from activating other protocols until the lockdown has been reset. Once the system has been reset, all data is saved once again, and the smart lighting system goes back to the original standby (e.g., referred to as system reset). A system administrator may manually return the smart lighting system to an inactive standby state which archives all data, turns off any active indicators, and resets all devices. If the threat is updated, it starts the method 300 over again. At block T, the smart lighting system can check to see if there are any activated smoke/heat detectors to detect a fire, weights would still be set appropriately to not lead anyone towards a fire.

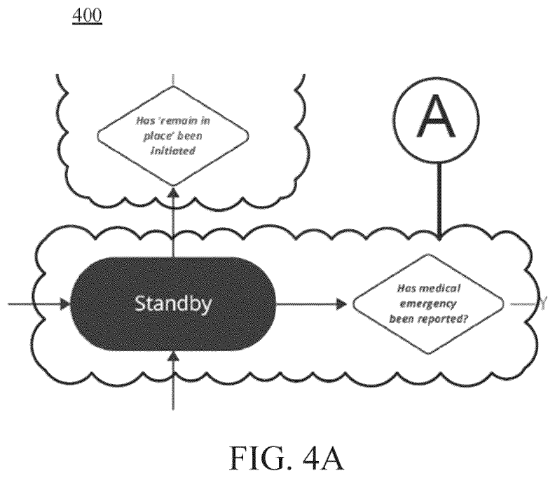

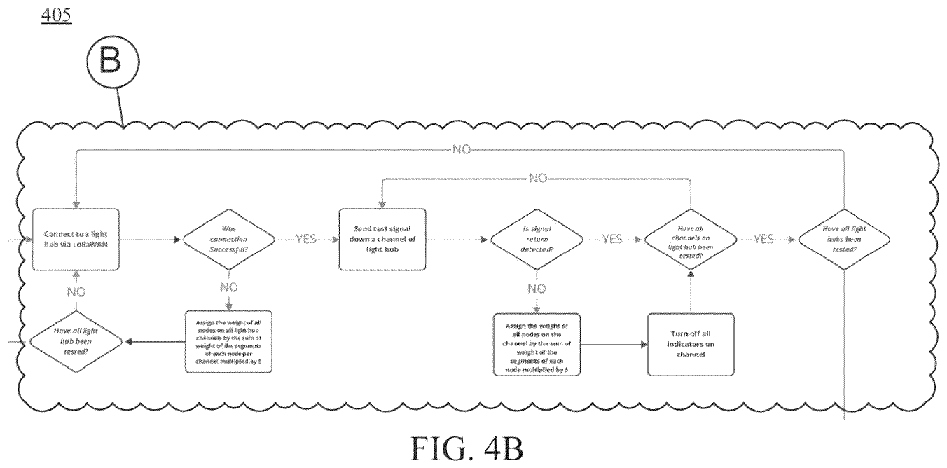

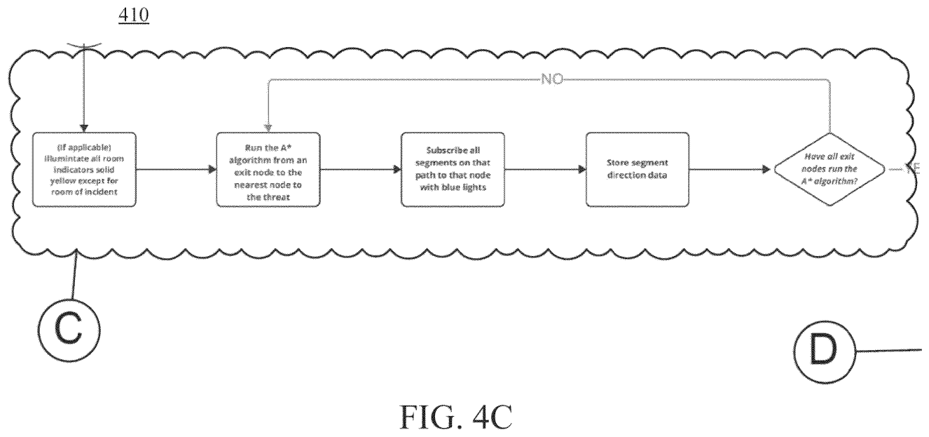

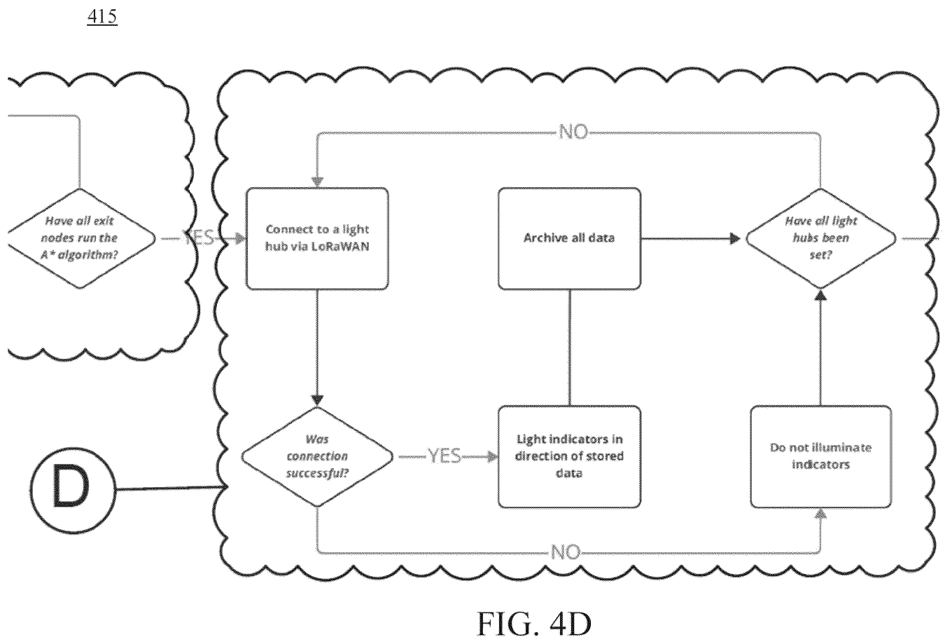

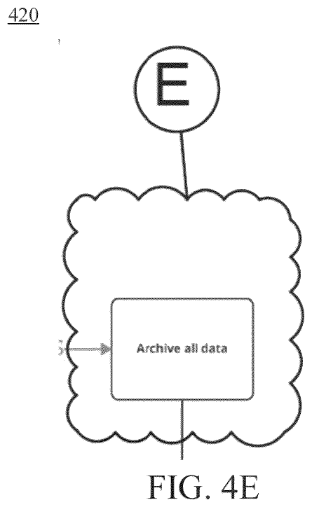

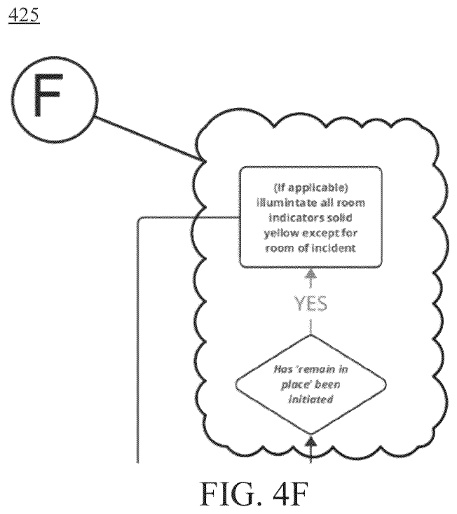

FIGS. 4A-4F illustrates a flow diagram of a method 400 executed in the smart lighting system 100. The example system 100 can perform the method 400 (referred to as the SEA* Algorithm) according to present implementations. It is to be appreciated that additional, fewer, or different operations (e.g., steps, substeps, etc.) than what is described herein may be performed depending on the particular arrangement. In some embodiments, some, or all operations of method 400 may be performed by a computing system (e.g., main hub 104, system 100) executing on one or more processors, systems, or servers. In various embodiments, each operation may be re-ordered, added, removed, or repeated.

The smart lighting system can be used for medical emergencies (e.g., heart attack, stroke, etc.) First responders can follow the blue lights which can bring the one or more persons directly to the medical emergency. The way that the method 400 is activated is from an authorized person that can input the location of the medical emergency using an electronic interface in a central command center. When a medical emergency has been identified, the main hub 104 processes the data with the method 400 and sends signals to each light system (e.g., light system 106) with information of which way the indicators (e.g., indicators 122) can illuminate blue. If at any illuminate the method 300 or the method 200 activates that can override this flowchart immediately. The system can stay activated until a reset signal is sent through an interface.

Referring now to FIG. 4A, at block A, the smart lighting system can be on standby waiting for a reported medical emergency. Referring now to FIG. 4B, at block B, the smart lighting system can connect to the light system and verify cable integrity and wiring connections. The smart lighting system can identity, determine, otherwise detect a first subset of nodes 126 that do not satisfy a threshold (e.g., broken, burned, faulty) causing a failure to connect to the light system and a second subset of nodes 126 that satisfy the threshold. The smart lighting system, can assign, indicate, or otherwise include a plurality of weights for each of the plurality of nodes 126. The weights assigned to the first subset of the plurality of nodes 126 can be lower than weights assigned to the second subset of the plurality of nodes 126. If there is a failure to connect to the light system or there is broken, burned, or faulty cable detected, he smart lighting system may decrease the weight of one or more nodes (e.g., nodes 126) connected to the faulty cable. The smart lighting system can determine the one or more navigation paths according to the weights assigned to each of the plurality of nodes 126. This is so that the SEA* Algorithm is less likely to go down a path with broken lights.

Referring now to FIG. 4C, at block C, an authorized person can input the location of the medical emergency using an electronic user interface in a central command center or the main hub. All room lights can illuminate solid yellow signaling a remain in place. The SEA* Algorithm is run starting at an exit node 126 and ending at the node 126 closest to the medical emergency and repeated for every exit. Once all exits have been subscribed to a path, the lights are illuminated blue to signal first responders to follow them towards the medical emergency. Referring now to FIG. 4D, at block D, the smart lighting system can connect to all the light systems and send signals to illuminate all indicators from the stored data. Referring now to FIG. 4E, at block E, the smart lighting system can save all for data (e.g., in system memory 108) for future use or investigation by storing, maintaining, or otherwise housing an association between the type of the event and the one or more navigation paths to the egress or location of the building. Referring now to FIG. 4F, at block F, the smart lighting system can check if remain in place has been initiated and illuminates solid yellow lights in all rooms to signal to not leave the room.

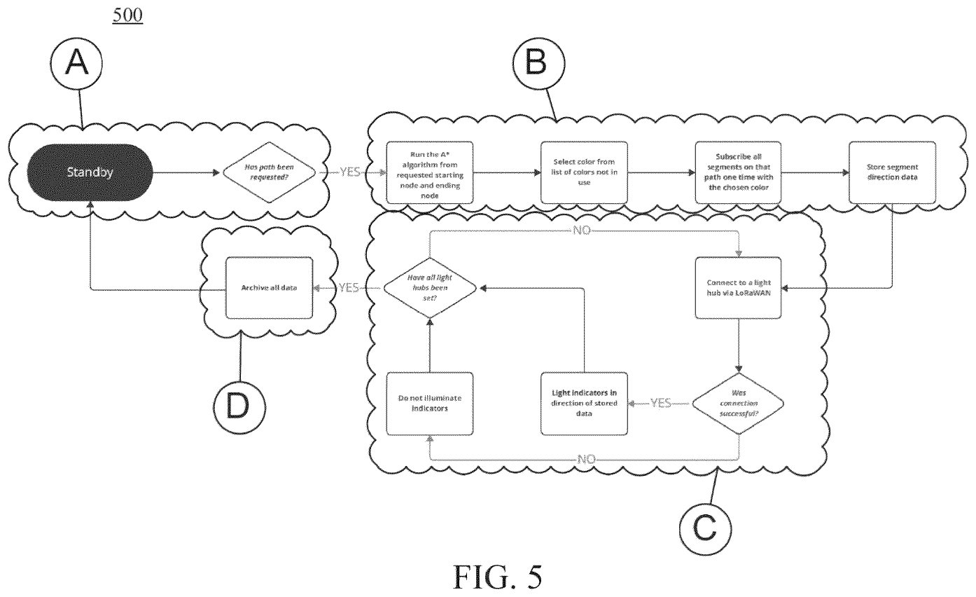

FIG. 5 illustrates a flow diagram of a method 500 executed in the smart lighting system 100. The example system 100 can perform the method 500 (referred to as the SEA* Algorithm) according to present implementations. It is to be appreciated that additional, fewer, or different operations (e.g., steps, substeps, etc.) than what is described herein may be performed depending on the particular arrangement. In some embodiments, some, or all operations of method 500 may be performed by a computing system (e.g., main hub 104, system 100) executing on one or more processors, systems, or servers. In various embodiments, each operation may be re-ordered, added, removed, or repeated.

At block A, the smart lighting system can be on standby waiting for a requested path. At block B, the smart lighting system can run the SEA* Algorithm from the starting node 126 to the ending node 126. Lights are then illuminated with an available color at a walking pace to the ending node. At block C, the smart lighting system can connect to all the light systems and sends signals to illuminate the indicators from the stored data. At block D, the smart lighting system can save all data (e.g., in system memory 108) for future use or investigation by storing, maintaining, or otherwise housing an association between the type of the event and the one or more navigation paths to the egress or location of the building.

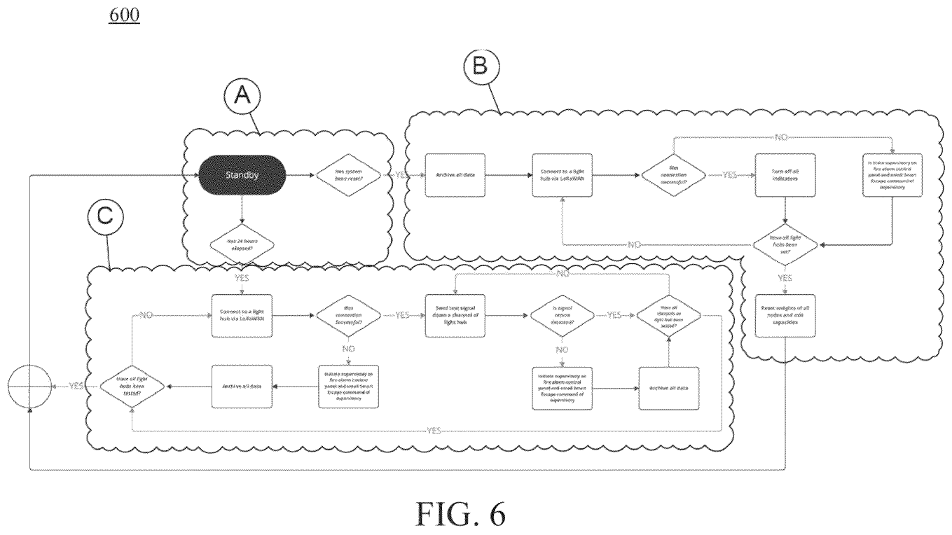

FIG. 6 illustrates a flow diagram of a method 600 executed in the smart lighting system 100. The example system 100 can perform the method 600 (referred to as the SEA* Algorithm) according to present implementations. It is to be appreciated that additional, fewer, or different operations (e.g., steps, substeps, etc.) than what is described herein may be performed depending on the particular arrangement. In some embodiments, some, or all operations of method 600 may be performed by a computing system (e.g., main hub 104, system 100) executing on one or more processors, systems, or servers. In various embodiments, each operation may be re-ordered, added, removed, or repeated.

At block A, the smart lighting system can be on standby waiting for the smart lighting system reset or after 24 hours has elapsed. At block B, the smart lighting system can save all data (e.g., in system memory 108) for future use or investigation by storing, maintaining, or otherwise housing an association between the type of the event and the one or more navigation paths to the egress or location of the building. The smart lighting system can connect to every light system and deactivate all lights. If there is a failure to connect to a light system, the system can initiate a supervisory on the fire alarm control unit (e.g., FACU 116) and sends an email to a user of the smart lighting system 100, so that the smart lighting system can identify broken components and get them fixed as soon as possible. All data is then saved for future use or investigation. At block C, the smart lighting system can connect to every light system and verify cable integrity and wiring connections. If there is a failure to connect to a light system or there is a broken/burned cable detected, the system can initiate a supervisory on the fire alarm control unit and send an email to a user of the smart lighting system 100, so that the smart lighting system can identify broken components and get them fixed as soon as possible. All data can be saved (e.g., in system memory 108) for future use or investigation.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for using a lighting system to navigate a building space, the method comprising:
receiving, by a computing system, a notice of an event, the computing system in communication with the lighting system, the lighting system comprising a plurality of hubs arranged along a plurality of pathways within a space of the building to one or more egresses or one or more locations of a building, each of the plurality of hubs comprising one or more visual indicators to indicate a direction towards an egress or a location along one or more of the plurality of pathways and to indicate a direction to avoid based on the event;
determining, by the computing system responsive to the notice, a location of the event and a type for the event;
determining, by the computing system, one or more navigation paths along the plurality of pathways within the building space for which one or more persons are to navigate to the egress or location of the building, based on the location and type for the event; and
causing, by the computing system, one or more hubs of the plurality of hubs corresponding to the one or more navigating paths to provide the one or more visual indicators in accordance with the location and type for the event.

2. The method of claim 1, wherein the event corresponds to at least one of a medical emergency, a fire emergency, environmental emergency, public health emergency, natural disasters, violence emergencies, or technological emergencies.

3. The method of claim 1, wherein the one or more visual indicators comprise a plurality of colors, further comprises determining, by the computing system, the plurality of colors to display on a subset of the one or more hubs based on the type of event, each of the plurality of colors indicating a message for the one or more persons.

4. The method of claim 1, wherein determining the location of the event and the type for the event, further comprising:
receiving, by the computing system from a plurality of sensors at a first time, signals corresponding to the event; and
identifying, by the computing system, the type of event using the signals at the first time.

5. The method of claim 1, further comprising:
receiving, by the computing system from a first sensor at a first time, a signal corresponding to the event; and
identifying, by the computing system, the location of event using signal at the first time.

6. The method of claim 5, further comprising:
receiving, by the computing system from a plurality of sensors at a second time, a second signal corresponding to the event; and
updating, by the computing system, the location of the event based on the second signal at the second time.

7. The method of claim 1, further comprising:
determining, by the computing system, a number of the one or more persons to navigate to the egress or the location of the building;
determining, by the computing system, a time for the number of the one or more persons to navigate to the egress or the location of the building; and
identifying, by the computing system, one or more navigation paths to a second egress or a second location of the building, responsive to the number of the one or more persons or the time exceeding a threshold.

8. The method of claim 1, further comprising:
receiving, by the computing system, an indication of an arrival of authorized personnel within the building; and
causing, by the computing system, the one or more hubs to provide one or more visual indicators indicating the arrival of the authorized personnel.

9. The method of claim 1, further comprising:
generating, by the computing system, a signal indicating the type of the event, the location of the event, the one or more navigation paths in the direction towards the egress or location of the building; and
transmitting, by the computing system, the signal to each of the plurality of hubs within the building.

10. The method of claim 1, further comprises storing, by the computing system, an association between the type of the event and the one or more navigation paths to the egress or location of the building.

11. The method of claim 1, further comprising:
identifying, by the computing system, a first subset of the plurality of hubs that do not satisfy a threshold and a second subset of the plurality of hubs that satisfy the threshold;
assigning, a plurality of weights for each of the plurality of hubs, wherein weights assigned to the first subset of the plurality of hubs is lower than weights assigned to the second subset of the plurality of hubs; and
determining, by the computing system, the one or more navigation paths according to the weights assigned to each of the plurality of hubs.

12. The method of claim 11, wherein assigning the plurality of weights, further comprising:
determining, by the computing system, a first hub that is activated in response to notice of the event;
assigning, the first hub with a maximum weight that is greater than each of the plurality of weights; and
determining, by the computing system, the one or more navigation paths according to the weights assigned to the plurality of hubs and the maximum weight assigned to the first hub.

13. A computing system to use a lighting system to navigate a building space, the computing system comprising:
one or more visual indicators,
a plurality of hubs; and
a main hub, comprising one or more processors coupled with memory, the one or more processors to:
receive, a notice of an event, the main hub in communication with a lighting system, the lighting system comprising a plurality of hubs arranged along a plurality of pathways within a space of the building to one or more egresses or one or more locations of a building, each of the plurality of hubs comprising one or more visual indicators to indicate a direction towards an egress or a location along one or more of the plurality of pathways and to indicate a direction to avoid based on the event;
determine, responsive to the notice, a location of the event and a type for the event;
determine one or more navigation paths along the plurality of pathways within the building space for which one or more persons are to navigate to the egress or location of the building, based on the location and type for the event; and
cause one or more hubs of the plurality of hubs corresponding to the one or more navigating paths to provide the one or more visual indicators in accordance with the location and type for the event.

14. The system of claim 13, wherein the event corresponds to at least one of a medical emergency, a fire emergency, environmental emergency, public health emergency, natural disasters, violence emergencies, or technological emergencies.

15. The system of claim 13, wherein the one or more visual indicators comprise a plurality of colors, wherein the one or more processors to determine the plurality of colors to display on a subset of the one or more hubs based on the type of event, each of the plurality of colors indicating a message for the one or more persons.

16. The system of claim 13, the one or more processors to:
receive, from a plurality of sensors at a first time, signals corresponding to the event; and
identify the type of event using the signals at the first time.

17. The system of claim 13, the one or more processors to:
receive, from a first sensor at a first time, a signal corresponding to the event; and
identify the location of event using the signal at the first time.

18. The system of claim 17, the one or more processors to:
receive, from a plurality of sensors at a second time, a second signal corresponding to the event; and
update the location of the event based on the second signal at the second time.

19. The system of claim 13, the one or more processors to:
determine a number of the one or more persons to navigate to the egress or the location of the building;
determine a time for the number of the one or more persons to navigate to the egress or the location of the building; and
identify one or more navigation paths to a second egress or a second location of the building, responsive to the number of the one or more persons or the time exceeding a threshold.

20. The system of claim 13, the one or more processors to store, by the computing system, an association between the type of the event and the one or more navigation paths to the egress or location of the building.
